(19) United States
(12) Patent Application Publication
(10) Pub. No.: US 2025/0324521 A1
(43) Pub. Date: Oct. 16, 2025

(54) SYSTEMS AND METHODS FOR TAMPER DETECTION

(71) Applicant: Varex Imaging Corporation, Salt Lake City, UT (US)

(72) Inventors: Kendra Jean Davis, Salt Lake City, UT (US); Chase C. Lewis, Charlottesville, VA (US); Louise Hammond McGowin, Salt Lake City, UT (US); Michael Rudolf Meiler, Draper, UT (US); Lincoln Curtis Jolley, Stansbury Park, UT (US)

(73) Assignee: Varex Imaging Corporation, Salt Lake City, UT (US)

(21) Appl. No.: 18/633,451

(22) Filed: Apr. 11, 2024

(51) Int. Cl. H05K 5/02; H05K 9/00

(52) U.S. Cl. CPC H05K 5/0208; H05K 9/0022

(57) ABSTRACT

Embodiments include a device, comprising: a mounting structure configured to mount the device to an external component; first circuitry; and anti-tamper circuitry configured to monitor an electromagnetic coupling between the device and the external component and to disable at least one function of the first circuitry in response to detection of a tamper event pertaining to the electromagnetic coupling.

### BACKGROUND

Systems may be formed from a variety of different devices. Manufacturers, system integrators, or the like may design and install a particular system with authorized components. However, a third-party supplier may attempt to exchange devices on similar systems, install used components, or third-party components that may lead to performance issues and/or damage to components of the system.

### BRIEF DESCRIPTION OF DRAWINGS

FIGS. 1A-1C are block diagrams of systems including a device with anti-tamper circuitry according to some embodiments. FIG. 2 is a block diagram of a device with anti-tamper circuitry according to some embodiments.

FIGS. 3A-3C are block diagrams of circuitry of devices with anti-tamper circuitry according to some embodiments.

FIG. 4A-4B are cross-sectional diagrams illustrating mounting a device with anti-tamper circuitry on an external component according to some embodiments.

FIGS. 5A-5D are schematic diagrams of circuitry of anti-tamper circuitry according to some embodiments.

FIGS. 6A-6H illustrate examples of anti-tamper systems configured to detect tamper events pertaining to an electromagnetic coupling.

FIGS. 7A-7F illustrate examples further examples of anti-tamper systems configured to detect tamper events pertaining to an electromagnetic coupling.

FIG. 8 is a schematic lock diagram illustrating an example of an anti-tamer device configured to monitor an electromagnetic coupling.

FIG. 9 is a schematic diagram of illustrating an example of anti-tamper circuitry.

FIGS. 10A and 10B are flowcharts showing techniques of operating a device with anti-tamper circuitry according to some embodiments.

FIGS. 11A and 11B are flowcharts illustrating examples of methods for detecting tamper events based, at least in part, on monitoring an electromagnetic coupling.

FIG. 12 is a block diagram of an x-ray system according to some embodiments.

FIG. 13A-13B are block diagrams of systems including an authorization system according to some embodiments.

FIGS. 14A-15C are flowcharts showing examples of techniques of operating an authorization system according to some embodiments.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Numbers provided in flow charts and processes are provided for clarity in illustrating steps and operations and do not necessarily indicate a particular order or sequence. Unless otherwise defined, the term “or” can refer to a choice of alternatives (e.g., a disjunction operator, or an exclusive or) or a combination of the alternatives (e.g., a conjunction operator, and/or, a logical or, or a Boolean OR).

Some embodiments relate generally to mechanisms, methods, and systems to disable component authentication system when removed from a component. Some embodiments relate generally to switches and disabling components and/or circuitry.

Electronic devices may be used in an attempt to block the use of third-party components in systems such as computed tomography (CT) and x-ray systems. However, such electronic devices may be removed from systems including old, broken, worn out components, such as x-ray tubes. The electronic devices may then be installed on third-party or used tubes to be sold for use in an original equipment manufacturer (OEM) system. For example, a third-party may access an old, used, or broken x-ray tube from which the electronic devices can be removed. The electronic device can then be installed on a new, used, or third-party tube to enable the tube to simulate a genuine tube in the system.

As described herein, anti-tamper circuitry may not prevent the removal of the components or the electronic devices themselves but may disable at least some to all of the functionality of the device such as disabling authentication or other functions, deleting configuration information, or the like. As a result, the electronic device may not be able to perform those functions without having a manufacturer or authorized service representative reprogram the device. Thus, an unauthorized party may no longer be able to reuse the electronic device and access some to all of the functionality. As will be described in further detail below, the effect of the loss of some to all of the functionalities may result in a range of effects from a warning message to disabling of the electronic device or a system including the electronic device.

In some embodiments, in an x-ray system, an x-ray tubes designed and built by the manufacturer may include tube specific information to be used in conjunction with a tube auxiliary unit (TAU) to function with proper imaging and without damage to the tube. That tube specific information may reside in non-volatile random-access memory (NVRAM), such as flash memory or solid-state storage, of the TAU. Since some of the information stored in the TAU is tube specific, if its TAU were to be swapped to a different tube, its tube specific information would no longer match the specific x-ray tube. The mismatch could cause image quality issues and/or irreparable x-ray tube damage if used. The anti-tamper circuitry may reduce or eliminate a chance that the TAU is swapped between different x-ray tubes and providing the incorrect tube specific information to a system.

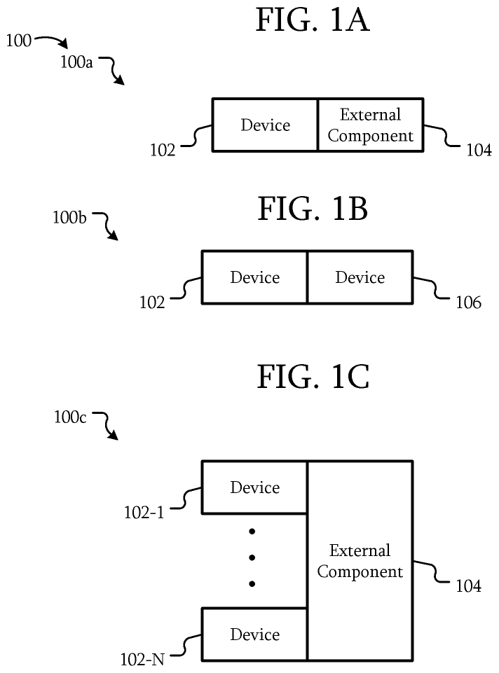

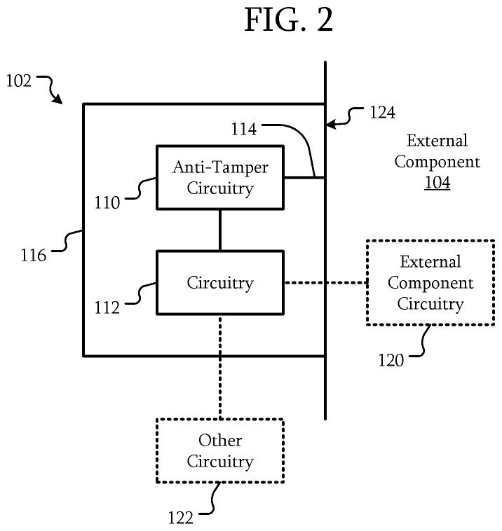

FIGS. 1A-1C are block diagrams of systems including a device with anti-tamper circuitry according to some embodiments. FIG. 2 is a block diagram of a device with anti-tamper circuitry according to some embodiments.

Referring to FIGS. 1A and 2, the system 100a includes a device 102 configured to be mounted to an external component 104. The device 102 includes anti-tamper circuitry 110 and circuitry 112.

Examples of the device 102 include devices with circuitry 112 that may include customized components, firmware, software, data or the like. The firmware or software may include instructions that implement proprietary communication and/or control techniques with other circuitry 122 or circuitry 120 of the external component 104. In other embodiments, the data may include authentication information, cryptographic information, performance data, or the like. Particular examples of the device 102 include an authentication circuit for a system, a control circuitry for an x-ray tube, or the like.

The external component 104 may include a purely structural component and/or a circuitry with some functional capabilities. For example, in some embodiments, the external component 104 is a housing of a system that includes the device 102. The device 102 may be mounted to that housing and hence, mounted to the external component 104.

The device 102 includes a housing 116 configured to restrict access to disarm the disarm the anti-tamper circuitry 110 when the device 102 is mounted to the external component 104. For example, the housing 116 may include a sealed case surrounding the anti-tamper circuitry 110 and the circuitry 112. When the housing 116 is mounted to the external component 104, the combination of the housing 116 and the external component 104, such as a wall 124 of the external component 104, may completely enclose the anti-tamper circuitry 110 and the circuitry 112. In some embodiments, the combination may enclose the anti-tamper circuitry 110 and the circuitry 112 sufficiently to prevent access to the anti-tamper circuitry 110 or the circuitry 112 without significantly modifying or destroying the housing 116. The combination of the housing 116 and the external component 104 may be configured such that accessing the anti-tamper circuitry 110 or the circuitry 112 is significantly more difficult than removing the device 102 from the external component 104.

The device 102 includes anti-tamper circuitry 110 electrically connected to circuitry 112. The anti-tamper circuitry 110 is configured to disable at least one function of the circuitry 112 when the device 102 is removed from the external component 104. In particular, the anti-tamper circuitry 110 is coupled to the external component 104 through coupling 114. This coupling 114 may be a mechanical, electrical, optical, magnetic, other similar couplings, or a combination of such couplings. For example, a switch may be switched when the device 102 is mounted on the external component 104. Switched can refer to either toggling from an on state to an off state or toggling from an off state to an on state. The switch may have a mechanically or magnetically switchable pole. A state of the switch may change depending on whether the device 102 is a mounted on the external component 104 or if it is being removed from the external component. In other embodiments, the switch may change state when a fastener that is used to mount the device 102 on the external component is removed. In other embodiments, an electrical circuit may be created through a portion of the external component 104, such as through a metallic portion of the wall 124. Removal of the device 102 from the external component may be detected by a break in that circuit. Although some circuits and structures have been used as examples of configurations by which the anti-tamper circuitry 110 may sense the removal of the device 102 from the external component 104, the anti-tamper circuitry 110 may sense the removal in other ways.

Embodiments described herein may be used anywhere where a device 102 should stay physically paired to the system 100a, the external component circuitry 120, the other circuitry 122, or another component or device to which they are mounted and/or associated. Paired in this sense could mean physically in touch, in proximity, in communication with, integrated into the device, or the like.

In response to sensing the removal of the anti-tamper circuitry 110 from the external component 104, the anti-tamper circuitry 110 may be configured to disable at least one function of the circuitry 112. The particular function of the circuitry 112 may include a capability of general processing, the use of particular data, the ability to properly respond to authentication challenges, or the like. In some embodiments, data stored in the circuitry 112 may be erased. The data may include cryptographic information, authentication information, identification information, operational information, firmware, software, or the like. In some embodiments, non-volatile memory of the circuitry 112 may be erased to disable at least one function. In other embodiments, fuses that affect operation of the circuitry 112 may be blown to disable at least one function. While some embodiments may disable at least one function, in other embodiments, the anti-tamper circuitry 110 may be configured to disable all functions of the circuitry 112 or the entire device 102.

In some embodiments, the circuitry 112 is configured to control the external component. The circuitry 112 may be coupled to the external component circuitry 120. In a particular example, the circuitry 112 may include control circuitry for an x-ray tube. The external component circuitry 120 may include an anode, cathode, filament, emitter, motor, steering electronics, focusing electronics, or other circuitry that may be part of an x-ray tube.

In some embodiments, other techniques for preventing reuse could be triggered by radio-frequency identification sensors (RFID), light sensors, proximity sensors, bar code readers, cameras that process the tube serial number or other identifying features, trip wires, tamper resistant mounting, or any combination of such techniques. These techniques could be paired with the ability of the anti-tamper circuitry 110 to disable at least one function of the circuitry 112 as described herein.

Referring to FIGS. 1B and 2, in some embodiments, the external component 104 may be another device 106. For example, the device 106 may be an interface circuit board configured to provide an interface between a system control component and other components of the system. In a particular example, the device 106 may be an interface board that converts controls and/or communication between the system controller for an x-ray system and particular sub-systems, such as an x-ray generation subsystem, a power sub-system, a detector sub-system, a cooling subsystem, a user interface sub-system, or the like.

The device 102 may be an authentication daughter board (ADB) configured to store authentication information, perform authentication functions, negotiate authentication between a system controller and the device 106 or other sub-systems of the system 100b, or the like.

Referring to FIG. 1C, in some embodiments, more than one device 102 may be mounted on the external component 104. In this example, N devices 102 are mounted on the external component 104. The devices 102-1 to 102-N may be the same, similar, or different. However, some to all of the devices 102-1 to 102-N may include the anti-tamper circuitry 110 described herein.

In some embodiments, the anti-tamper circuitry 110 prevents the reuse, modification, tampering, replacement, or reinstallation of the device 102, by a third-party or onto a third-party component. As described above, the device 102 may be part of an authentication system. The authentication system may be configured to determine whether or not a component in the system, which may be the device 102, the external component 104, or another component, is a genuine manufacturer or OEM component by issuing an encrypted challenge question to a cryptographic electronic device on the component.

In a particular example, the device 102 may include the cryptographic electronic device as part of the circuitry 112. The device 102 includes the circuitry that controls the external component 104. If the cryptographic electronic device can be removed from the genuine component and installed on a counterfeit component, then the authentication system can be defeated. However, the anti-tamper circuitry 110 is triggered upon removal of the device 102. The at least one function of the circuitry 112 that is disabled may include the authentication functions, authentication information, or the like. After the anti-tamper circuitry 110 is triggered, the cryptographic electronic device would no longer respond properly to authentication requests. As a result, the system 100 would have an indication that the device 102 and/or external component 104 can no longer be trusted to be a genuine manufacturer or OEM component.

In some embodiments, service contracts may be a large source of revenue for an OEM. Anti-tamper circuitry 110 as described herein may be used by the OEM to reduce or eliminate an ability of third-party manufacturers or resellers to install competing or replacement products, or incompatible components that can result in performance and patient safety issues.

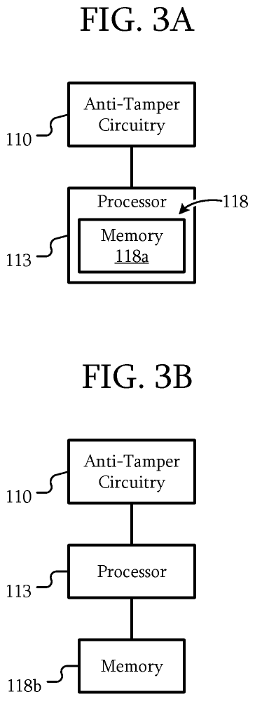

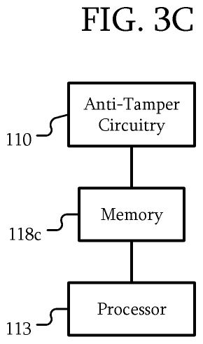

FIGS. 3A-3C are block diagrams of circuitry of devices with anti-tamper circuitry according to some embodiments. In these embodiments, the circuitry includes anti-tamper circuitry 110 similar to that described above, a processor 113, and a memory 118. The processor 113 and memory 118 are examples of circuitry 112 described above.

The processor 113 may be a general-purpose processor, a digital signal processor (DSP), an application specific integrated circuit, a microcontroller, a programmable logic device, discrete circuits, a combination of such devices, or the like. The processor 113 may include internal portions, such as registers, cache memory, volatile memory, non-volatile memory, processing cores, or the like, and may also include external interfaces, such as address and data bus interfaces, interrupt interfaces, or the like. Although only one processor 113 is illustrated, multiple processors 113 may be present. In addition, other interface devices, such as logic chipsets, hubs, memory controllers, communication interfaces, or the like may be included to connect the processor 113 to internal and external components.

The processor 113 is coupled to the memory 118. The memory 118 includes data such as cryptographic information, authentication information, identification information, operational information, firmware, software, or the like as described above. The anti-tamper circuitry 110 is configured to erase at least a portion of the memory 118 used by the processor 113 when the device 102 is removed from the external component 104. In some embodiments, the erasure may be of all of such data. In other embodiments, the erasure may be of a sufficient quantity and quality of the data to render the device 102 inoperable, such as the erasure of secret information such as cryptographic keys.

Referring to FIG. 3A, in some embodiments, the processor 113 includes on-chip or otherwise integrated memory 118a. As a result, when the anti-tamper circuitry 110 erases at least a portion of the memory 118a, the memory erased is memory integrated with the processor 113.

Referring to FIG. 3B, in some embodiments, the anti-tamper circuitry 110 is coupled to the processor 113. The processor 113 is coupled to external memory 118b. The anti-tamper circuitry 110 may be configured to activate the processor 113 and cause the processor 113 to execute commands to erase the at least a portion of the external memory 118b. For example, the anti-tamper circuitry 110 may cause the processor to execute an interrupt service routine that erases the portion of the memory 118b. In another example, the anti-tamper circuitry 110 may be configured to boot the processor 113 in a mode specifically designed to erase the portion of the memory 118b. Although the processor 113 is illustrated as being directly coupled to the memory 118b, in other embodiments, other intervening circuitry may be present, such as a memory controller.

Referring to FIG. 3C, in some embodiments, the anti-tamper circuitry 110 may be configured to access the memory 118c without accessing the processor 113. Accordingly, the anti-tamper circuitry 110 may be configured to erase the portion of the memory by controlling the memory 118c.

While a variety of configurations of the anti-tamper circuitry 110, processor 113, and memory 118 have been described above, in other embodiments, the anti-tamper circuitry 110, processor 113, and memory 118 may be coupled in any manner such that the anti-tamper circuitry 110 may cause the portion of the memory 118 used by the processor 113 to be erased.

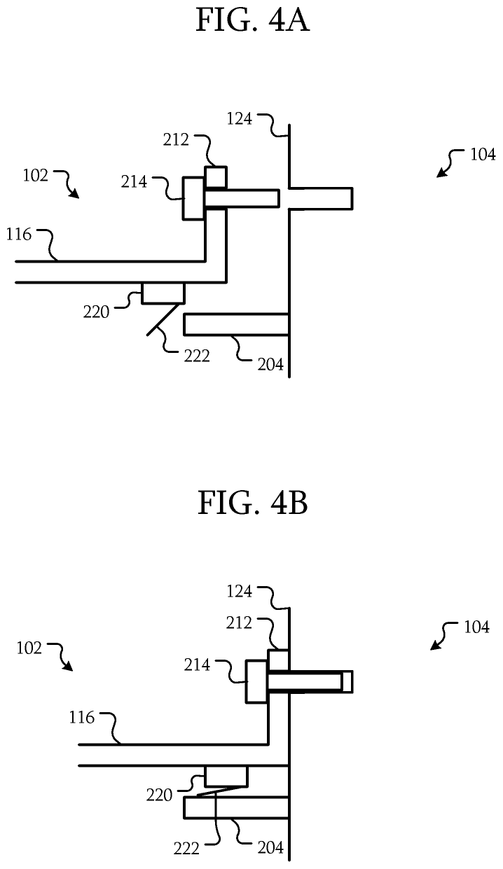

FIG. 4A-4B are cross-sectional diagrams illustrating mounting a device with anti-tamper circuitry on an external component according to some embodiments. FIG. 4A illustrates a state of a device 102 and an external component 104 before the device 102 is mounted to the external component 104 or after the device 102 is removed from the external component 104. FIG. 4B illustrates a state of the device 102 and the external component 104 when the device 102 is mounted to the external component 104.

Referring to FIGS. 4A and 4B, in some embodiments, the device 102 includes a housing 116. The device 102 includes a switch 220. The switch 220 is coupled to the housing 116. Although the housing 116 is illustrated as an example of a mounting structure of the device 102, in other embodiments, the mounting structure may be a structure other than the housing 116. The mounting structure may be any structure, board, component, or the like that remains with the device 102 when the device is moved relative to the external component 104. The housing includes a flange 212. A fastener 214 may be used to attach the housing 116 to the wall 124 of the external component 104. While mounting components such as the flange 212 and fastener 214 have been used as examples, in other embodiments, different mounting techniques may be used.

The switch 220 is configured to switch when the device 102 is removed from the external component 104. When the device 102 is in the state illustrated in FIG. 4A, the switch 220 has a pole 222 in a first state. In a particular example, the switch 220 may be a momentary normally closed switch. Thus, in the state illustrated in FIG. 4A, the switch 220 is closed.

As the device 102 is mounted on the external component 104 as illustrated in FIG. 4B, a structure 204 of the external component 104 causes the pole 222 of the switch 220 to switch. Thus, the switch 220 is opened.

In some embodiments, the structure 204 is a protrusion, wall, rib, gusset, fastener, or the like. The structure 204 disposed on the external component 104 such that when the device 102 is mounted on the external component 104, the structure 204 toggles the state of the switch 220.

Although a particular structure of the device 102, external component 104, and switch 220 has been used as an example, any mechanism and associated structures may be used that causes the switch 220 to be in a first state when mounted and in a second state when removed. In particular, the mechanism and associated structures may be formed such that the switch 220 changes state before the anti-tamper circuitry 110 may be accessed to disable the anti-tamper circuitry 110 or otherwise prevent it from disabling at least one function of the circuitry 112 as described above.

In addition, the switch 220 need not be mechanically switched. For example, the switch 220 may be magnetically switched. The structure 204 may include a magnet or a ferromagnetic material according to the structure of the switch 220 such that the switch 220 changes state as the device 102 is mounted to or removed from the external component 104.

While a single switch 220 has been used as an example, in other embodiments, multiple switches 220 in different locations and/or different configurations may be used. In some embodiments, any one of these switches 220 may be used by the anti-tamper circuitry 110 to disable at least one function of the circuitry 112.

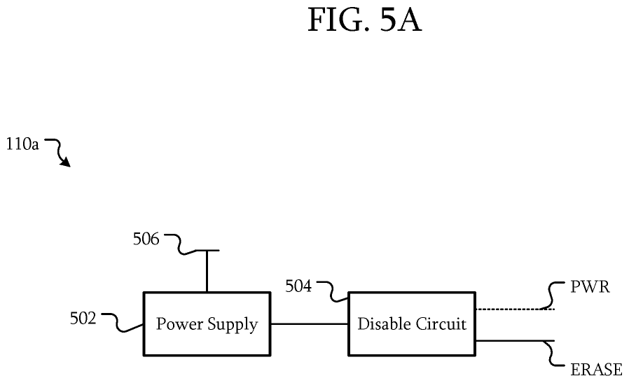

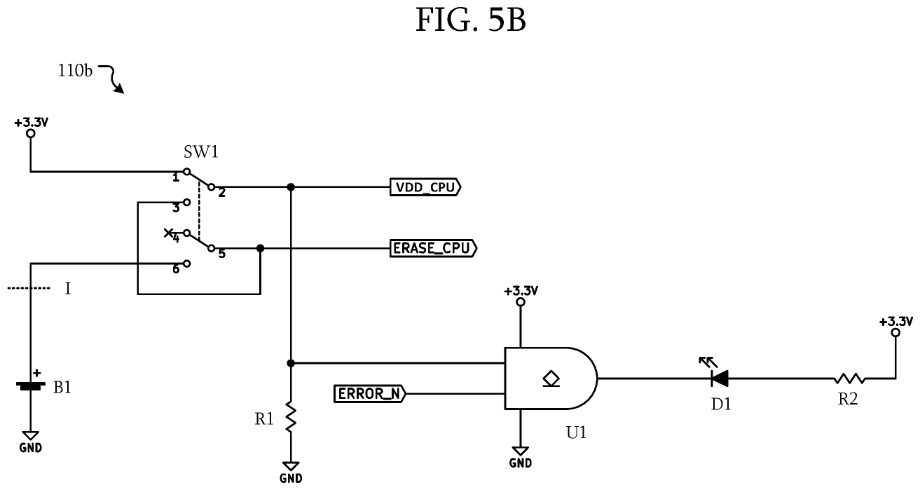

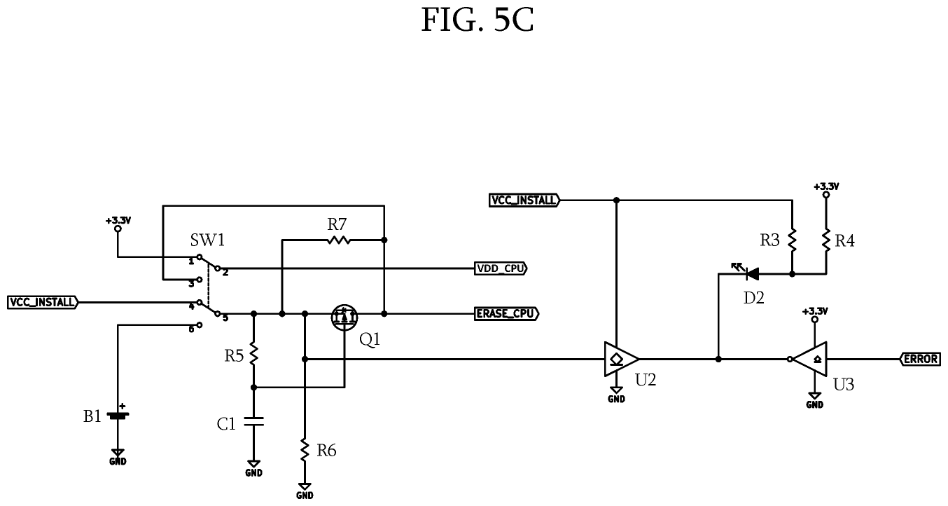

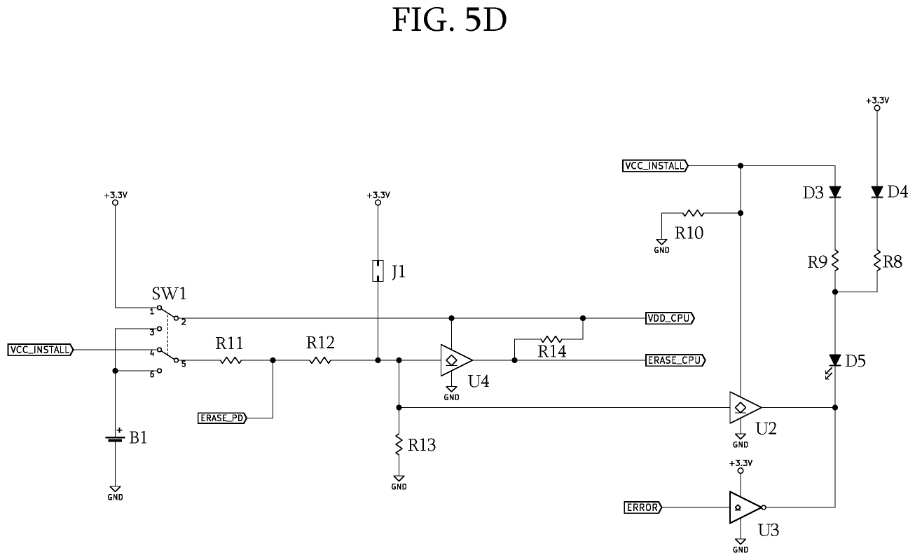

FIGS. 5A-5D are schematic diagrams of circuitry of anti-tamper circuitry according to some embodiments. Referring to FIG. 5A, the anti-tamper circuitry 110a includes a power supply 502 and a disable circuit 504. The power supply 502 is configured to generate power that may be used by the disable circuit 504 and potentially a portion of the circuitry 112.

The power supply 502 is disposed within the device 102. The power supply 502 is configured to supply power after detecting removal of the device 102 from the external component 104. The power supply 502 may include a battery, a capacitor, a supercapacitor, or any other energy storage device that may be disposed within the device 102. In some embodiments, the power supply 502 may be charged by an external power source 506.

In some embodiments, the power supply 502 may include switches that connect the power supply 502 to other components of the anti-tamper circuitry 110 when the device 102 is removed from the external component 104.

The disable circuit 504 is a circuit configured to disable the at least one function of the circuitry 112. In this example, the disable circuit 504 includes an ERASE output. The ERASE output is a signal coupled to an ERASE input on a processor, memory, or the like of the circuitry 112 that would initiate an erase command to erase memory or otherwise disable the at least one function.

In some embodiments, power PWR may also be provided to some components of the circuitry 112. In particular, the device 102 may not be connected to an external power source or the external power source may be disabled when the device 102 is being removed from the external component 104. The power supply 502 may instead supply the power needed to allow the disable circuit 504 to disable the at least one function of the circuitry 112.

Referring to FIG. 5B, the anti-tamper circuitry 110b includes battery B1 and switch SW1. A single battery B1 is illustrated; however, in other embodiments, multiple batteries may be used. The switch SW1 is a double-pole double-throw switch (DPDT). The switch SW1 is coupled such that in the illustrated state, 3.3V is coupled to VDD_CPU and no connection is made to ERASE-CPU. In the other state, both VDD_CPU and ERASE_CPU are coupled to the battery B1.

VDD_CPU is a power supply for a processor that may be part of the circuitry 112. ERASE_CPU is a signal that commands the processor of the circuitry 112 to erase some or all of its memory. As a result, the at least one function of the circuitry 112 may be disabled. The switch SW1 is illustrated in the state when the corresponding device 102 is mounted to the external component 104. When removed, the switch SW1 will transition to the other state, which will supply power to the processor through VDD_CPU and supply the erase signal through ERASE_CPU.

The isolator I is a removable structure configured to disconnect the battery B1 from the switch. When in place, the battery B1 be disconnected and will not supply power to the switch SW1. Thus, ERASE_CPU will not be activated. The isolator I may be in place during installation to disable the anti-tamper circuitry 110b.

Other circuitry illustrated may provide a status indicator for a variety of states. R1 is coupled to VDD_CPU and pulls down the input to AND gate U1. The other input to AND gate U1 is an error signal ERROR_N. When the device 102 is being installed and the 3.3V power is applied, the switch SW1 will be in the opposite state. However, as the isolator I is present, the battery will not enable ERASE_CPU. VDD_CPU will not be coupled to 3.3V and will be pulled down by R1. Thus, the output of AND gate U1 will be low, turning on LED D1. Once the device 102 is properly installed, the switch SW1 will change to the illustrated state and VDD_CPU will be set to 3.3V. The AND gate U1 output will switch to high, assuming there is no error indicated by a low on ERROR_N. The high output will cause the LED D1 to turn off. As a result, an installer will receive a visual indication that the device 102 is installed such that the switch SW1 is in the illustrated state.

Once installed, the isolator I may be removed. ERROR_N will control the output of the AND gate U1 and whether LED D1 is on. Thus, the LED D1 will act as an error indicator. However, if the device 102 is removed, the switch SW1 will change state, activating VDD_CPU and ERASE_CPU.

In an example, the SW1 switch is a normally closed (NC) double pole, double throw (DPDT) switch where the closed state couples the battery B1 to ERASE_CPU. The switch can be normally closed (NC) and open when the switch is depressed, such as when the device 102 is installed and a feature of the external component 104 presses on the switch.

Referring to FIG. 5C, the operation may be similar to that of FIG. 5B. However, VCC_INSTALL is a power voltage supplied during installation when 3.3V may not be active. Resistors R3 and R4 are in series with LED D2 for either VCC_INSTALL or 3.3V. Thus, when the cathode of LED D2 is pulled low, LED D2 will turn on. Buffer U2 is an open-drain buffer. Inverter U3 is an open-drain inverter. Thus, if the input to U2 is low or if the input to U3 is high, the LED D2 will be turned on.

When the switch is in the installed state, ERASE_CPU and the nodes coupled to resistors R5, R6, R7, and Q1 are pulled to ground and transistor Q1 is off. However, once the device 102 is removed from the external component 104, switch SW1 changes state, increasing the voltage of node N1, pulsing ERASE_CPU until C1 charges. R5 and C1 are selected to provide a sufficient pulse to erase a portion of the memory to disable the at least one function.

Referring to FIG. 5D, the operation of U2, U3, resistors R8, R9, and R10, diodes D3 and D4, and LED D5 may be similar to that of FIG. 5C. Here diodes D3 and D4 may isolate VCC_INSTALL from 3.3V. The operation of the anti-tamper circuitry 110d may be similar to that of anti-tamper circuitry 110c of FIG. 5C.

Although 3.3V has been used as an example of a power supply voltage, in other embodiments, the power supply voltage may be different.

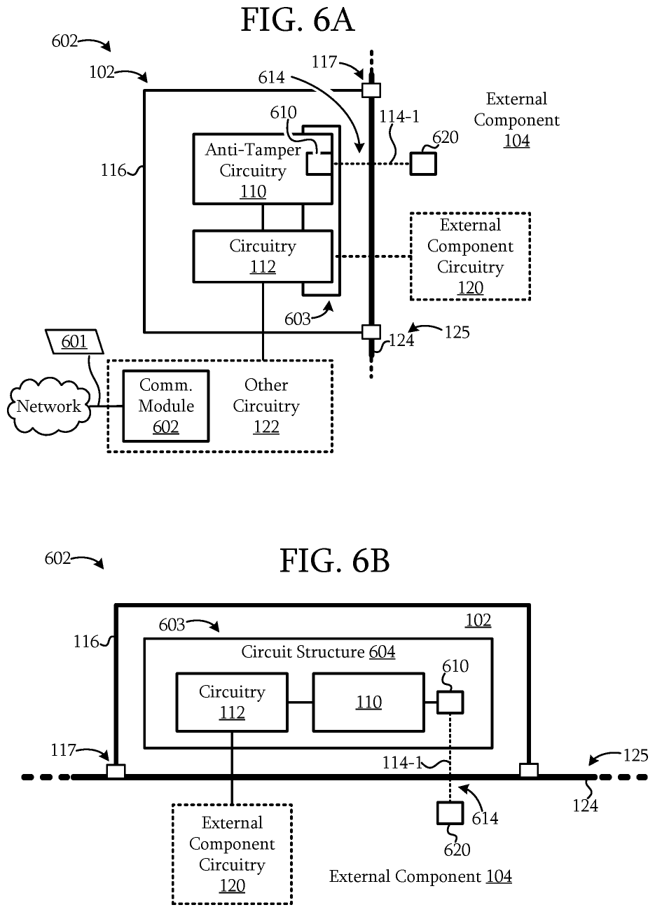

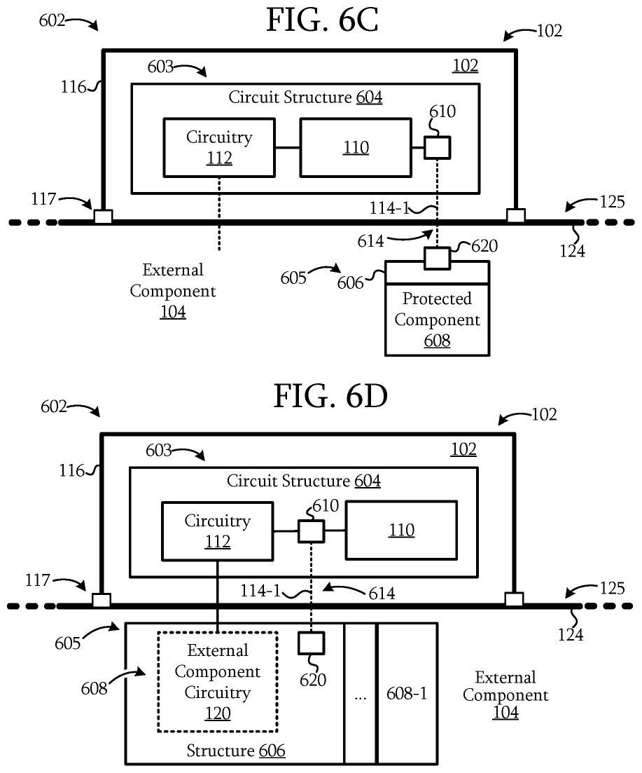

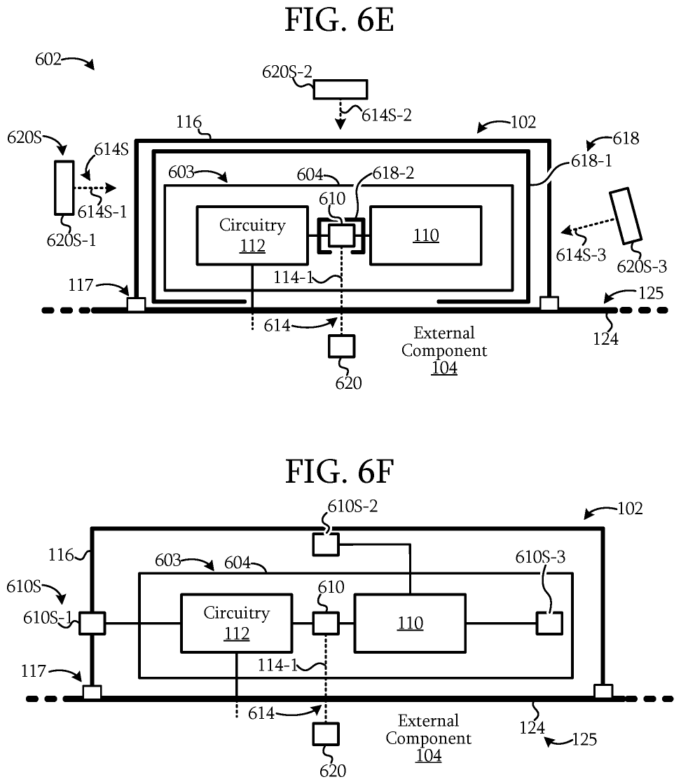

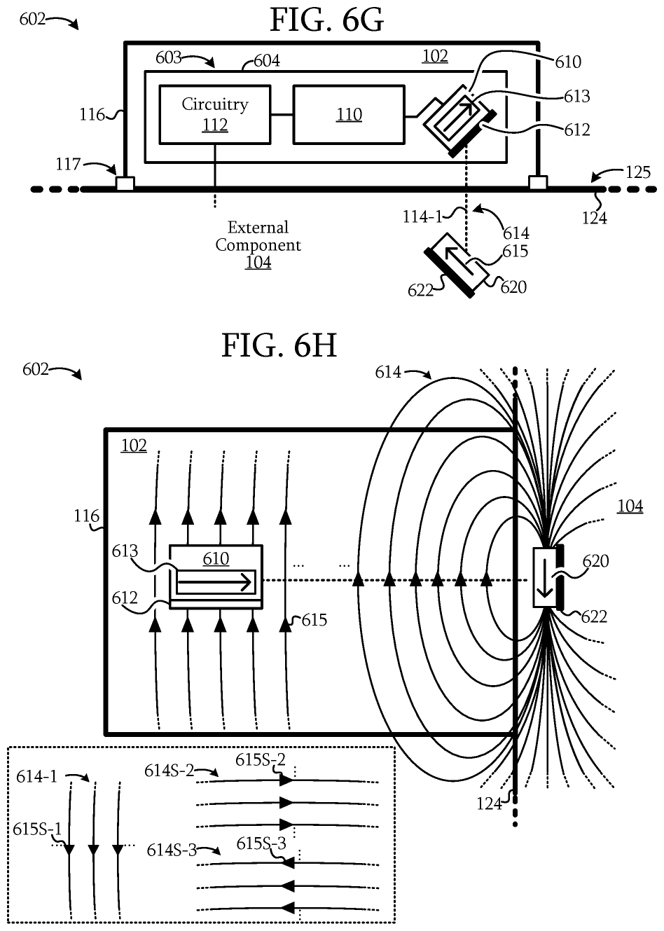

Although particular examples of couplings 114 are described herein, the disclosure is not limited in this regard. In some implementations, the anti-tamper circuitry 110 disclosed herein may be configured to monitor an electromagnetic coupling 114-1, as illustrated in FIG. 6A.

FIG. 6A is a schematic block diagram illustrating an example of an anti-tamper system 602 configured to detect tamper events based, at least in part, on an electromagnetic coupling 114-1. As used herein, a “tamper event” may comprise and/or refer to an event indicative of an attempt to gain unauthorized access to the device 102 and/or external component 104. A tamper event may comprise and/or refer to an attempt to separate the device 102 from the external component 104, gain access to internals of the external component 104, separate the anti-tamper circuitry 110 from the device 102, separate the anti-tamper circuitry 110 from the circuitry 112, separate the anti-tamper circuitry 110 from the external component 104, separate the circuitry 112 from the external component 104, bypass the anti-tamper circuitry 110 (e.g., spoof the electromagnetic coupling 114-1), and/or the like. The anti-tamper circuitry 110 may be configured to detect tamper events pertaining to the electromagnetic coupling 114-1, such as interruptions to the electromagnetic coupling 114-1, attempts to spoof the electromagnetic coupling 114-1, and/or the like.

The anti-tamper circuitry 110 may be configured to implement one or more mitigation actions in response to detection of a tamper event. In some implementations, the mitigation actions may include generating tamper notifications 601 pertaining to detected tamper events. As used herein, a tamper notification 601 may comprise and/or refer to electronic data comprising information pertaining to the detection of a tamper event. A tamper notification 601 may comprise, inter alia, information pertaining to the tamper event detected by the anti-tamper circuitry 110, such as interruption to the electromagnetic coupling 114-1, detection of an attempt to spoof the electromagnetic coupling 114-1 (e.g., detection of an external magnetic field), attempt to remove the device 102 from the external component 104 (e.g., detect actuation of the switch 220 illustrated in FIGS. 4A and 4B), and/or the like. Tamper notifications 601 may further comprise information pertaining to the device 102 and/or external component 104, such as device identifiers, component identifiers, model numbers, serial numbers, version numbers, stock keeping unit (SKU) numbers, system identifiers (as disclosed in further detail herein), and so on. Tamper notifications 601 may further comprise information pertaining to the owner of the device 102 and/or external component 104, e.g., may comprise a customer identifier, customer name, contact information (e.g., email address), and/or the like.

In some implementations, tamper notifications 601 may be maintained within non-transitory storage of the anti-tamper circuitry 110 (and/or circuitry 112). Alternatively, or in addition, the anti-tamper circuitry 110 may be configured to transmit tamper notifications 601 over a network. The network may comprise any suitable electronic communication means including, but not limited to: an electronic communication network, a computer network, a wired network, a wireless network, a local area network (LAN), a wide area network (WAN), a virtual private network (VPN), Internet Protocol (IP) networks, Transmission Control Protocol/Internet Protocol (TCP/IP) networks, the Internet, a public switched telephone network (PSTN), a cellular communication network, a cellular data network, a satellite network, a Near Field Communication (NFC) network, a Bluetooth network, a mesh network, a grid network, and/or the like.

The anti-tamper circuitry 110 may be configured to transmit tamper notifications 601 to a designated recipient, such as a manufacturer of the device 102 and/or external component 104. The tamper notifications 601 may be communicated according to any suitable protocol and/or messaging scheme, including, but not limited to: electronic mail, text messaging, a short messaging service (SMS), and/or the like.

In some implementations, the mitigation actions implemented in response to detection of a tamper event may comprise disabling functionality of the external component 104, as disclosed herein. For example, the mitigation actions may comprise erasing data, erasing contents of a memory, disabling one or more components, and/or the like. As disclosed herein, the anti-tamper circuitry 110 may be configured to disable at least one function of the circuitry 112 in response to detection of a tamper event such that remounting the device 102 to the external component 104 (and/or otherwise clearing the tamper event) does not reenable the at least one function of the circuitry 112.

As used herein, “clearing” a tamper event (or “clearance” of a tamper event) may comprise and/or refer to a change in conditions pertaining to a tamper event. By way of non-limiting example, the anti-tamper circuitry 110 may clear a tamper event corresponding to interruption of the electromagnetic coupling 114-1 in response to determining that the electromagnetic coupling 114-1 has been reestablished. The anti-tamper circuitry 110 may trigger a tamper event in response to a strength of the magnetic field 614 detected by the sensor 610 falling below a threshold and may clear the tamper event when the strength of the magnetic field 614 detected by the sensor 610 satisfies the threshold. For example, removing the device 102 from the external component 104 may move the sensor 610 away from the source 620, which may decrease the strength of the magnetic field 614 detected by the sensor 610, thereby triggering a tamper event. Such a tamper event may be cleared when the strength of the magnetic field 614 detected by the sensor 610 satisfies the threshold, e.g., when the device 102 is reattached to the external component 104. By way of further non-limiting example, the anti-tamper circuitry 110 may detect a tamper event in response to detection of another magnetic field, e.g., a second magnetic field different to the magnetic field 614 produced by the source 620. As disclosed in further detail herein, detection of the second magnetic field may be indicative of an attempt to bypass or spoof the anti-tamper circuitry 110 and, as such, may trigger a tamper event. Such a tamper event may be cleared when the second magnetic field is removed (or is no longer detected).

The anti-tamper circuitry 110 may be configured to maintain the mitigation actions implemented for a tamper event in response to clearance of the tamper event. For example, the anti-tamper circuitry 110 may be configured to disable one or more functions of the circuitry 112 in response to detection of a tamper event pertaining to the electromagnetic coupling 114-1 (e.g., in response to detecting interruption of the electromagnetic coupling 114-1) such that the one or more functions remain disabled in response to clearance of the tamper event. In other words, the one or more functions may be maintained in a disabled state regardless of whether the electromagnetic coupling 114-1 is reestablished. By way of further example, the anti-tamper circuitry 110 may be configured to disable one or more functions of the circuitry 112 in response to detection of an attempt to spoof the electromagnetic coupling 114-1, e.g., may detect a second magnetic field. The anti-tamper circuitry 110 may disable the one or more functions such that the one or more functions remain disabled in response to clearance of the spoof attempt, e.g., may remain disabled after the second magnetic field is removed (or is no longer detected).

In the FIG. 6A example, the electromagnetic coupling 114-1 comprise and/or be implemented by a sensor 610 and source 620. The sensor 610 may be configured to sense, detect, and/or otherwise monitor an electromagnetic radiation (EMR) signal generated by the source 620. The anti-tamper circuitry 110 may be triggered in response to interruption of the EMR signal. The sensor 610 may be configured to trigger the anti-tamper circuitry 110 in response to failing to detect the EMR signal generated by the source 620 and/or in response to a strength of the EMR signal failing to satisfy a threshold.

The source 620 may comprise any suitable means for generating EMR signals and the sensor 610 may comprise any suitable means for detecting such signals. In the FIG. 6A example, the source 620 may be configured to generate a magnetic field 614. In other words, the electromagnetic coupling 114-1 may comprise a magnetic coupling. The source 620 may comprise any suitable means for generating a magnetic field 614 including, but not limited to a permanent magnet, a ferromagnetic material, a rare-earth magnet, a Neodymium magnet, a samarium cobalt magnet, an alnico magnet, a ceramic magnet, a ferrite magnet, an electromagnet, and/or the like. The sensor 610 may comprise any suitable means for sensing, detecting, and/or otherwise monitoring magnetic fields including, but not limited to a magnetic field sensor, an inductive sensor, a tunneling magnetoresistance (TMR) sensor, a Hall effect sensor, a Reed sensor, a micro-electromechanical (MEMS) sensor, a Lorentz-force based MEMS sensor, a superconducting quantum interference device (SQUID), and/or the like.

The sensor 610 may be configured to trigger the anti-tamper circuitry 110 in response to detecting a tamper event pertaining to the magnetic coupling 114-1. The sensor 610, for example, may detect a tamper event in response to interruption of the magnetic coupling 114-1. In some implementations, the sensor 610 may be configured to trigger the anti-tamper circuitry 110 in response to failing to detect the magnetic field 614 generated by the source 620 and/or in response to a magnetic flux density detected by the sensor 610 falling below a threshold. By way of non-limiting example, sensor 610 may trigger the anti-tamper circuitry 110 in response to the strength of the magnetic field 614 detected thereby falling below a threshold, e.g., trigger←Gₛ≤Gₜₕ, where trigger represents detection of a tamper event, Gₛ represents the strength of the magnetic field 614 detected by the sensor 610 (in Gauss or other suitable measure), and Gₜₕ represents a magnetic field strength threshold. The strength of the magnetic field 614 produced by the source 620 may decrease as a function of distance. Accordingly, displacement of the sensor 610 relative to the source 620 may result in interruption of the electromagnetic coupling 114-1. The sensor 610, therefore, may trigger detection of a tamper event when a distance between the sensor 610 and source 620 exceeds a threshold, as follows, e.g., trigger←dₛₑₚ≥dₜₕ, where dₜₕ is a distance threshold and dₛₑₚ is an offset, displacement, and/or other measure of distance between the sensor 610 and source 620. The distance threshold (dₜₕ) may be based on and/or derived from the magnetic field strength threshold (Gₜₕ) as follows, Gₜₕ=Gₛ (dₜₕ), where Gₛ is a function configured to model the strength of the magnetic field 614 produced by the source 620 as a function of distance.

In some implementations, the anti-tamper circuitry 110, sensor 610, and/or circuitry 112 may be disposed within an enclosure or housing 116 of a device 102. The housing 116 and/or other structural elements. The device 102 may be configured to be coupled to the external component 104 by, inter alia, attachment means 117. The attachment means 117 may comprise any suitable means for attaching, connecting, coupling, and/or otherwise securing the device 102 to the external component 104. The attachment means 117 may include but are not limited to: mounting components and/or fasteners (e.g., flange 212 and/or fastener 214 as illustrated in FIGS. 4A and 4B), screws, welding, adhesives (e.g., glue, epoxy, and/or the like), bolts, weld nuts, rivets, anchors, and/or the like. The device 102 may be attached to a housing 125 of the external component 104, such as a wall 124 and/or other structural elements, as disclosed herein.

The electromagnetic coupling 114-1 may be configured such that movement of the device 102 relative to the external component 104 results in corresponding movement of the anti-tamper circuitry 110 (and/or sensor 610) relative to the external component 104 (and/or source 620). Accordingly, removal or other separation of the device 102 from the external component 104 may interrupt the electromagnetic coupling 114-1 and, as such, trigger detection of a tamper event by the anti-tamper circuitry 110.

In some implementations, the anti-tamper system 602 may comprise a physical coupling 603 configured to couple the circuitry 112 to the anti-tamper circuitry (and/or sensor 610). As disclosed in further detail herein, the physical coupling 603 may comprise a structural component, such as a circuit support structure or the like. The electromagnetic coupling 114-1 may, therefore, couple the circuitry 112 to the external component 104 controlled by the circuitry 112. In other words, the physical coupling 603 may be configured such that movement of the circuitry 112 relative to the external component 104 results in corresponding movement of the anti-tamper circuitry 110 (and/or sensor 610) relative to the source 620. The electromagnetic coupling 114-1 may detect attempts to separate the circuitry 112 from the external component 104 regardless of whether the device 102 remains attached the external component 104. Moreover, the electromagnetic coupling 114-1 may detect attempts to separate the circuitry 112 from the external component 104 regardless of compromise to the attachment means 117 (and/or integrity of the housing 116 of the device 102, housing 125 of the external component 104, and/or the like).

FIG. 6B is a block diagram illustrating another example of a device 102 configured to detect tamper events based, at least in part, on an electromagnetic coupling 114-1. In the FIG. 6B example, the device 102 may comprise a physical coupling 603 between the circuitry 112 and anti-tamper circuitry 110 (and/or sensor 610). The physical coupling 603 may comprise a circuit structure 604. For example, the anti-tamper circuitry 110, circuitry 112, and/or sensor 610 may be disposed and/or implemented on a same or common circuit structure 604. The circuit structure 604 may comprise any suitable means for implementing and/or supporting circuitry including, but not limited to: a package, a chip, a printed wiring board (PWB), a printed circuit board (PCB), and/or the like.

The physical coupling 603 between the circuitry 112 and anti-tamper circuitry 110 (and sensor 610) may be configured such that movement of the circuitry 112 relative to the external component 104 results in corresponding movement of the anti-tamper circuitry 110 (and/or sensor 610) relative to the external component 104. More specifically, movement of the circuitry 112 relative to the external component 104 may result in corresponding movement of the sensor 610 relative to the source 620. As disclosed herein, movement of the sensor 610 relative to the source 620 may disrupt the electromagnetic coupling 114-1 (e.g., reduce the strength of the magnetic field 614 detected by the sensor 610), which may trigger detection of a tamper event. The physical coupling 603 illustrated in the FIG. 6B example may enable the anti-tamper circuitry 110 (and sensor 610) to detect tamper events pertaining to the circuitry 112 regardless of whether other components of the device 102 are compromised, e.g., regardless of whether the housing 116 is removed or compromised.

FIG. 6C is a block diagram illustrating another example of a device 102 configured to detect tamper events based, at least in part, on an electromagnetic coupling 114-1. As disclosed herein, the source 620 of the electromagnetic coupling 114-1 may be physically coupled to the external component 104. For example, the source 620 may be embedded within the wall 124, housing 125, and/or other structural element(s) of the external component 104. FIG. 6C illustrates another example of a physical coupling 605 between the sensor 610 and external component 104. The physical coupling 605 may comprise and/or be implemented by a structure 606. The structure 606 may comprise any suitable structural components, e.g., may comprise the wall 124, enclosure, housing, mounting, and/or other structural elements of the external component 104. The structure 606 may be configured to physically couple the sensor 610 to one or more functional elements of the external component 104. In the FIG. 6C example, the physical coupling 605 may be configured to physically couple the sensor 610 to a protected component 608. The source 620 may be physically attached to the protected component 608, e.g., may be secured, attached to, embedded within, and/or otherwise affixed to the protected component 608. Alternatively, or in addition, the physical coupling 605 may comprise a structure 606 configured to physically couple the sensor 610 to the protected component 608. For example, the structure 606 may comprise a support, mount, board, and/or the like. In some implementations, the protected component 608 may comprise aspects of the external component circuitry 120 and the structure 606 may comprise a PCB or the like, e.g., the sensor 610 and external component circuitry 120 may be disposed and/or implemented on a same circuit structure.

The physical coupling 605 may be configured such that the anti-tamper circuitry 110 can detect tamper events pertaining to the protected component 608 regardless of compromise of the device 102 and/or external component 104. For example, the anti-tamper circuitry 110 may detect separation of the protected component 608 from the circuitry 112 regardless of the integrity of the device housing 116, attachment means 117, external component housing 125, and/or the like.

FIG. 6D is a block diagram illustrating another example of a device 102 configured to detect tamper events based, at least in part, on an electromagnetic coupling 114-1. In the FIG. 6D example, the anti-tamper circuitry 110 (and/or sensor 610) may be physically coupled to the circuitry 112, as disclosed herein, e.g., by a physical coupling 603, such as a circuit structure 604 or the like.

The source 620 of the electromagnetic coupling 114-1 may be physically coupled to one or more protected components 608. As illustrated in FIG. 6D, the sensor 610 may be physically coupled to the external component circuitry 120. For example, the sensor 610 and external component circuitry 120 may be disposed and/or implemented on a same PCB or the like. Alternatively, or in addition, the physical coupling 605 may be configured to physically couple the sensor 610 to other types of protected components 608. For example, the structure 606 may be configured to physically couple the sensor 610 to a protected component 608-1, such as an x-ray tube, x-ray tube enclosure, or the like. The physical coupling 605 may be configured such that the anti-tamper circuitry 110 can detect attempts to separate the circuitry 112 from the protected components 608, regardless of whether the device 102 and/or external component 104 are compromised. More specifically, since the anti-tamper circuitry 110 (and sensor 610) are physically coupled to the circuitry 112 and the one or more protected components 608 are physically coupled to the source 620, the anti-tamper circuitry 110 may ensure that the circuitry 112 remains in proximity to the protected components 608 even if the circuitry 112 and/or protected components 608 are removed from their respective enclosures (e.g., removed from the device 102 and/or external component 104, respectively).

In some implementations, the anti-tamper device 102 may be further configured to prevent spoof attacks. As used herein, a “spoof attack” or “spoof attempt” may comprise and/or refer to an attempt to bypass anti-tamper detection by, inter alia, spoofing the electromagnetic coupling 114-1 and/or magnetic field 614 generated by the source 620. A spoof attack may comprise generating a spoof magnetic field 614S in the vicinity of the device 102, the spoof magnetic field 614S configured to be detected by the sensor 610 such that interruption of the electromagnetic coupling 114-1 (and/or failure of the sensor 610 to detect the magnetic field 614 generated by the source 620) fails to trigger detection of a tamper event. The anti-tamper device 102 may comprise any suitable means for preventing spoof attacks including, but not limited to: shielding (e.g., means for shielding the sensor 610 from spoof magnetic fields 614S), secondary sensors 610S (e.g., sensors 610S configured to trigger detection of a tamper event in response to detection of a spoof magnetic field 614S), configuring the sensor 610 detect magnetic fields 614 having a designated orientation (and/or ignoring spoof magnetic fields 614S having other orientations), and/or the like. FIGS. 6E through 6H illustrate examples of means for preventing spoof attacks. The disclosure is not limited in this regard, however, and could be adapted to include any suitable spoof prevention means and/or multiple means for spoof prevention. For example, implementations of the disclosed anti-tamper device 102 may comprise a combination of shielding means, secondary sensing means, orientation-specific detection means, and/or the like.

FIG. 6E is a block diagram illustrating further aspects of anti-tamper circuitry 110, as disclosed herein. In FIGS. 6E-6H, aspects of the external component 104 are omitted to avoid obscuring details of the illustrated examples, e.g., external component circuitry 120, physical coupling 605, and so on.

The device 102 illustrated in the FIG. 6E example may be configured to prevent attempts to spoof the electromagnetic coupling 114-1 (and/or magnetic field 614). As disclosed herein, a spoof attempt (or spoof attack) may comprise and/or refer to an attempt to bypass anti-tamper detection by, inter alia, establishing a second electromagnetic coupling configured to replicate or “spoof” the first, or primary electromagnetic coupling 114-1 of the anti-tamper device 102. A spoof attack may comprise generating one or more “spoof” magnetic fields 614S in the vicinity of the device 102 and/or sensor 610. The spoof magnetic fields 614S may be generated by one or more external or “spoof” sources 620S. FIG. 6E, illustrates an example of a spoof attack involving a plurality of spoof sources 620S-1 through 620S-3, each configured to generate a respective spoof electromagnetic field 614S, e.g., 614S-1 through 614S-3. The spoof sources 620S-1 through 620S-3 may be disposed at respective locations relative to the sensor 610 and the corresponding electromagnetic fields 614S-1 through 614S-3 may couple to the sensor 610 at respective orientations (as disclosed in further detail herein). A successful spoof attack may comprise causing the sensor 610 to detect a spoof magnetic field 614S at sufficient strength (e.g., detect a spoof magnetic field 614S, such that G_{spoof}≥Gₜₕ), which may enable the electromagnetic coupling 114-1 to be interrupted without triggering a tamper event. In other words, a successful spoof attack may allow the anti-tamper circuitry 110 to be separated from the external component 104 (and/or source 620) without triggering detection of a tamper event.

In some implementations, the device 102 may secure the anti-tamper circuitry from spoof attempts by use of shielding 618. The shielding 618 may be configured to block electromagnetic radiation originating from outside the device 102 and/or external component 104. In other words, the shielding 618 may be configured to allow electromagnetic radiation to be transmitted to the sensor 610 from the source 620 while blocking electromagnetic other than the magnetic field 614, blocking spoof sources 620S-1 through 620S-3. The shielding 618 may comprise any suitable means for regulating the transmission of electromagnetic radiation (e.g., magnetic fields 614) including, but not limited to: passive shielding, mechanical shielding, a faraday cage, mu-metal (e.g., shielding 618 comprising a material having a high magnetic permeability), and/or the like. In some implementations, the shielding 618 may be incorporated into a housing, enclosure, and/or other structural elements of the device 102. The shielding 618 may, for example, be incorporated into the housing 116 of the anti-tamper device 102. In some implementations, aspects of the shielding 618 may be implemented as a separate component of the device 102. As illustrated in FIG. 6E, the device 102 may comprise shielding 618-1 configured to protect the circuit structure 604 comprising the sensor 610 and/or anti-tamper circuitry 110 from external electromagnetic signals, e.g., may be configured to partially enclose the circuit structure 604. Alternatively, or in addition, the device 102 may comprise shielding 618-2 configured to isolate the sensor 610 from external electromagnetic signals, e.g., may be configured to partially enclose the sensor 610.

FIG. 6F is a block diagram illustrating another approach to spoof prevention. In the FIG. 6F example, the anti-tamper device 102 may be configured to secure the anti-tamper circuitry 110 from spoof attacks by use of, inter alia, one or more secondary sensors 610S. The secondary sensors 610S may be positioned away from the source 620 such that the secondary sensors 610S do not detect the first magnetic field 614 (and/or detect the first magnetic field 614 at a low strength, such that G_{snd}<<Gₜₕ, where G_{snd} represents a magnetic field strength detected by a secondary sensor 610S corresponding to the first magnetic field 614).

In some implementations, secondary sensors 610S may be placed at the periphery of the device 102 and, as such, may be capable of detecting spoof magnetic fields 614S originating outside the device 102 and/or external component 104. In other words, the secondary sensors 610S may be positioned to have a higher sensitivity to spoof magnetic fields 614S as compared to the primary sensor 610. The device 102 may comprise zero or more secondary sensors 610S. In some implementations, the device 102 may comprise a single secondary sensor 610S. In the FIG. 6F example, the device 102 comprises three secondary sensors 610S-1 through 610S-3, each disposed at a respective position at, or near, the periphery of the device 102. For example, the secondary sensor 610S-1 may be disposed on the housing 116 of the device 102, the secondary sensor 610S-2 may be disposed above the primary sensor 610 (relative to the source 620), and the secondary sensor 610S-3 may be disposed at an opposite end of the device 102 relative to secondary sensor 610S-1. The secondary sensors 610S may comprise separate, independent sensor devices. Alternatively, or in addition, one or more secondary sensors 610S may be physically coupled to the anti-tamper circuitry 110 (and/or circuitry 112). In the FIG. 6F example, the secondary sensor 610S-3 may be implemented on the circuit structure 604.

Detection of a magnetic field by a secondary sensor 610S may trigger detection of a tamper event (e.g., trigger detection of a “spoof attempt” tamper event). Detection of a spoof attempt may result in implementation of one or more mitigation actions, as disclosed herein. For example, detection of a spoof attempt may comprise disabling at least one function of the circuitry 112, may comprise erasing data (e.g., erasing a memory), may comprise generating and/or transmitting a tamper notification 601, and/or the like. A secondary sensor 610S may trigger detection of a spoof attempt in response to detection of a magnetic field strength that exceeds a spoof threshold. The spoof threshold may be higher than the detection threshold of the first, primary sensor 610, e.g., may be configured such that Gₜₕ≤G_{sp_th}, where Gₜₕ is the magnetic field strength threshold used to monitor the primary magnetic field 614 (e.g., electromagnetic coupling 114-1) and G_{sp_th} is a spoof attempt threshold used to trigger detection of a spoof attack by secondary sensors 610S-1 through 610S-3. The trigger condition of a secondary sensor 610S may be expressed as follows: trigger←G_{snd}≥G_{sp_th}, where G_{snd} is the strength of the spoof magnetic field 614S detected by the secondary sensor 610S.

FIG. 6G is a block diagram illustrating an example of an anti-tamper device 102 comprising spoof prevention means, as disclosed herein. In the FIG. 6G example, the anti-tamper circuitry 110 may comprise and/or be coupled to a sensor 610 configured to detect magnetic field energy at a designated orientation. The sensor 610 may, for example, comprise a unipolar device or the like. The sensor 610 may be configured to detect magnetic fields (and/or magnetic flux) having a specified orientation. As illustrated in FIG. 6G, the sensor 610 may be configured to detect magnetic flux in a perpendicular orientation to a designated sensor orientation 613 and may ignore (and/or be less sensitive) to magnetic flux in other orientations.

The anti-tamper device 102 may be configured to align the sensor orientation 613 to the field orientation 615 of the source 620, e.g., configure the sensor orientation 613 in accordance with the orientation of the magnetic field 614 generated by the source 620. As illustrated in FIG. 6G, the sensor 610 may be disposed at a designated position within the device 102, e.g., at sensor position 612 and the source 620 may be disposed at a designated position within the external component 104, e.g., at a source position 622. The sensor position 612 and/or source position 622 may determine, inter alia, a relationship between the sensor orientation 613 and the orientation of the magnetic field 614 generated by the source 620, e.g., field orientation 615. In the FIG. 6G example, the sensor position 612 and/or source position 622 may be configured such that the sensor orientation 613 is substantially perpendicular to the field orientation 615, e.g., substantially perpendicular to magnetic flux generated by the source 620. The sensor orientation 613 may, therefore, be closely coupled (highly sensitive) to the magnetic field 614 and uncoupled (or less sensitive) to magnetic fields having other orientations.

FIG. 6H illustrates further aspects of the coupling between the sensor orientation 613 and field orientation 615 of the source 620. In FIG. 6H, aspects of the device 102 are omitted to avoid obscuring details of the illustrated examples, e.g., anti-tamper circuitry 110, circuitry 112, physical coupling 603, circuit structure 604, shielding 618, secondary sensors 610S, and so on.

As illustrated in FIG. 6H, the sensor position 612 and source position 622 may be configured such that the sensor orientation 613 is substantially perpendicular to the field orientation 615 (and/or magnetic flux) of the magnetic field 614 generated by the source 620. The sensor 610 may not detect (and/or be less sensitive) to other magnetic fields having other orientations, such as spoof magnetic fields 614S. As illustrated in FIG. 6H, spoof magnetic field 614S-1 may have an orientation 615S-1 that is substantially opposite of field orientation 615, the orientations 615S-2 and 615S-3 of spoof magnetic fields 614S-2 and 614S-3 may be substantially parallel (or antiparallel) relative to the sensor orientation 613. The sensor 610 may, therefore, substantially ignore spoof magnetic fields 614S-1 through 614S-3.

Although particular examples of means for preventing spoof attacks are described herein, the disclosure is not limited in this regard and could be adapted to incorporate any suitable spoof prevention means and/or a combination of spoof prevention means, e.g., may comprise shielding 618 as illustrated in FIG. 6E, secondary sensors 610S as illustrated in FIG. 6F, a sensor 610 and/or source 620 having designated orientations as illustrated in FIGS. 6G and 6H, and so on.

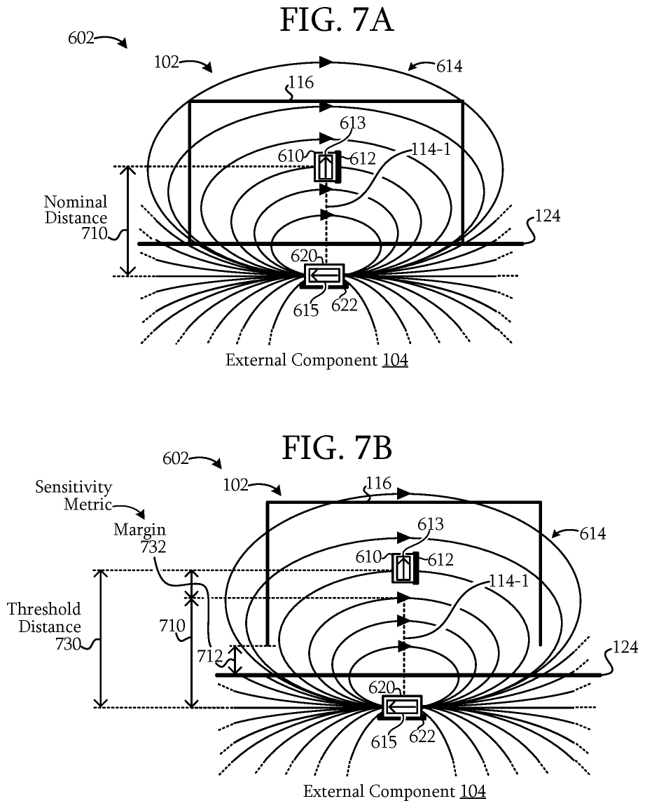

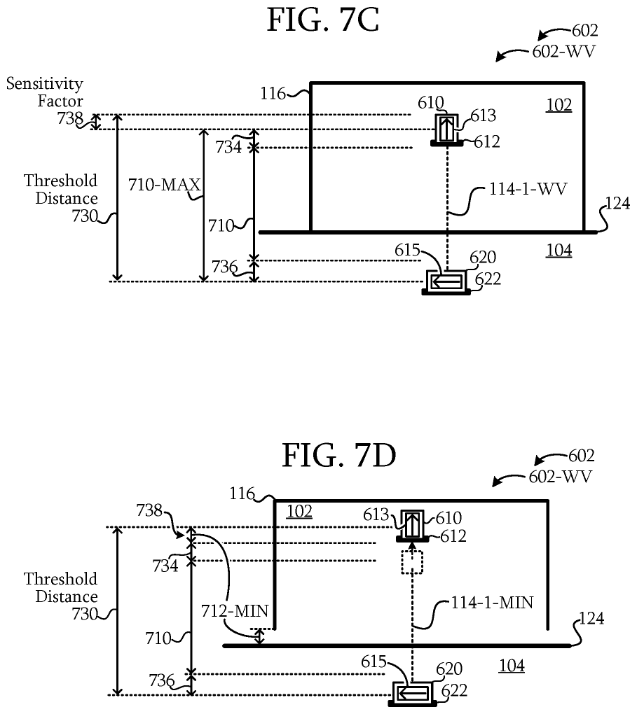

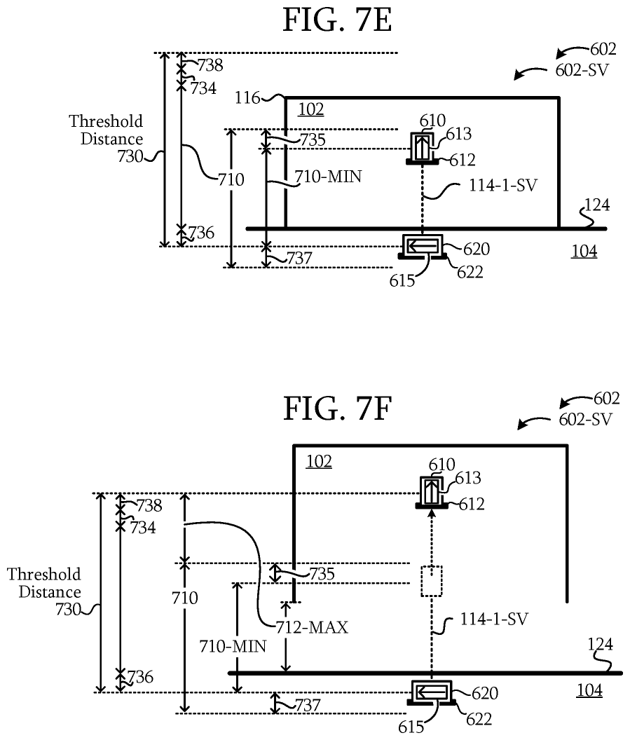

FIG. 7A illustrates further aspects of an anti-tamper system 602 comprising an electromagnetic coupling 114-1, as disclosed herein. In FIG. 7A, aspects of the device 102 and external component 104, such as the anti-tamper circuitry 110 and circuitry 120 are omitted to avoid obscuring details of the illustrated examples. The anti-tamper devices 102 illustrated in FIGS. 7A-7F may comprise spoof prevention means as disclosed herein (spoof prevention means not shown in FIGS. 7A-7F to avoid obscuring details of the illustrated examples).

FIG. 7A illustrates an example of an anti-tamper system 602 under nominal conditions and/or in a nominal configuration or state. As used herein, nominal conditions refer to conditions indicative of nominal operation of the anti-tamper system 602 and/or electromagnetic coupling 114-1, e.g., nominal conditions not indicative of a tamper event. Similarly, a nominal configuration or state of the anti-tamper system 602 may refer to a configuration or state not indicative of a tamper event. In other words, nominal conditions and/or a nominal configuration of the anti-tamper system 602 may refer to a configuration or state in which the anti-tamper device 102 is attached to the external component 104. The anti-tamper system 602 may detect deviation from nominal by, inter alia, monitoring the electromagnetic coupling 114-1. The anti-tamper circuitry 110 may be configured to detect a tamper event in response to the magnetic field strength detected by the sensor 610 falling below a threshold (Gₜₕ). The magnetic field strength detected by the sensor 610 may decrease as a function of distance between the sensor 610 and source 620. Magnetic field strength may be expressed as a function Gₛ(d), where d represents distance. Gₛ(d) may be highly sensitive to distance, e.g., may be inversely proportional to distance cubed, or 1/d³. Separation between the device 102 and external component 104 may result in corresponding separation between the sensor 610 and source 620, resulting in interruption of the electromagnetic coupling 114-1 and detection of a tamper event.

As illustrated in FIG. 7A, the sensor 610 and source 620 may be disposed at respective locations relative to one another, e.g., at a sensor position 612 and source position 622, respectively. The sensor 610 may be disposed within the device 102, e.g., may be affixed, secured, embedded and/or otherwise attached the housing 116 of the device 102, the anti-tamper circuitry 110, the circuitry 112, a circuit structure 604 such as a PCB, and/or the like (not shown in FIG. 7A to avoid obscuring details of the illustrated examples). The source 620 may be disposed within the external component 104, e.g., may be affixed, secured, embedded and/or otherwise attached to the wall 124 of the external component 104, the external component circuitry 120, a structure 606, a protected component 608, and/or the like (not shown in FIG. 7A to avoid obscuring details of the illustrated examples). The sensor 610 may be disposed within the device 102 such that movement of the device 102, anti-tamper circuitry 110, and/or circuitry 112 relative to the external component 104 results in corresponding movement of the sensor 610 relative to the source 620 (and magnetic field 614). Similarly, the source 620 may be disposed within the external component 104 such that movement of the external component 104, external component circuitry 120, and/or protected component 608 relative to the device 102 (and/or anti-tamper circuitry 110) results in corresponding movement of the source 620 (and magnetic field 614) relative to the sensor 610.

The sensor position 612 and/or source position 622 may be configured such that, when the device 102 is attached and/or otherwise secured to the external component, the sensor 610 is displaced from the source 620 at a nominal distance 710, e.g., the sensor 610 may be disposed at a nominal offset, displacement, distance, and/or vector relative to the source 620. In other words, when the anti-tamper system 602 is in a nominal configuration of state, the sensor 610 may be separated from the source 620 by the nominal distance 710. In some implementations, the electromagnetic coupling 114-1 may be configured such that Gₛ(dₙₒₘ)>Gₜₕ, where dₙₒₘ represents the nominal distance 710. Accordingly, when the device 102 is attached to the external component 104, the sensor 610 may detect a magnetic field strength that satisfies the field strength threshold (Gₜₕ) and, as such, the sensor 610 may not trigger detection of a tamper event.

FIG. 7B illustrates an example of an anti-tamper device 102 configured to detect tamper events. In the FIG. 7B example, the anti-tamper system 602 may no longer be in a nominal configuration or state as in FIG. 7A. In the FIG. example, the device 102 may be separated from the external component 104. As disclosed herein, such movement may result in corresponding separation of the sensor 610 from the magnetic field 614 of the source 620. For example, the sensor 610 may be physically coupled to the anti-tamper circuitry 110, and/or circuitry 112 (e.g., may be disposed on a same circuit structure 604) and the source 620 may be physically coupled to the external component circuitry 120 and/or protected component 608 (may be disposed on a same structure 606). Accordingly, movement of the device 102 and/or circuitry 112 relative to the external component 104, external component circuitry 120, and/or protected component 608 may result in corresponding movement of the sensor 610 relative to the source 620 (and magnetic field 614 generated thereby).

In the FIG. 7B example, the device 102 may be separated from the external component 104. The magnetic field strength detected by the sensor 610 may, therefore, fall from Gₛ(dₙₒₘ) as in FIG. 7A to Gₛ(dₙₒₘ+dₛₑₚ), where dₛₑₚ represents the separation distance between the device 102 and external component 104. As disclosed herein, the anti-tamper system 602 may be configured to detect a tamper event in response to the magnetic field strength detected by the sensor 610 failing to satisfy a magnetic field strength threshold (Gₜₕ), such trigger criteria may be expressed as follows:

$$trigger ← {G}_{s} \leq {G}_{th} \qquad Eq . 1$$

The device 102 may be separated from the external component 104, resulting in a corresponding drop to the magnetic field strength detected by the sensor 610, e.g., to Gₛ(dₙₒₘ+dₛₑₚ)<Gₛ(dₙₒₘ). In the FIG. 7B example, the device 102 (and/or sensor 610) may be separated from the external component 104 (and/or source 620) by a trigger distance 712 (d_{trigger}), which may cause the magnetic field strength detected by the sensor 610 to fall to or below Gₜₕ, e.g., Gₛ (dₙₒₘ+d_{trigger})≤Gₜₕ. In other words, the trigger distance 712 (d_{trigger}) may represent a threshold distance 730 (dₜₕ) at which the anti-tamper circuitry 110 may detect tamper events, as follows:

$$trigger ← {G}_{s} ( d ) \leq {G}_{th} , where {G}_{th} = {G}_{s} ( {d}_{th} ) \qquad Eq . 2$$

$$trigger ← {d}_{s e p} \leq {d}_{th}$$

The distance threshold 730 may be expressed in terms of the nominal distance 710 between the sensor 610 and source 620, per Eq. 3 below:

$${G}_{th} = {G}_{s} ( {d}_{th} ) = {G}_{s} ( {d}_{n o m} + {d}_{m g n} ) \qquad Eq . 3$$

$${d}_{th} = {d}_{n o m} + {d}_{m g n}$$

As illustrated in Eq. 3, the magnetic field strength threshold (Gₜₕ) utilized to trigger the anti-tamper circuitry 110 may correspond to a magnetic field strength acquired by the sensor 610 at the threshold distance 730 from the source 620, where the threshold distance 730 comprises a sum of the nominal distance 710 (dₙₒₘ) and a margin 732 (d_{mgn}). The magnetic field strength threshold (Gₜₕ) and corresponding threshold distance 730 (and/or margin 732 thereof) may determine a sensitivity or sensitivity metric of the electromagnetic coupling 114-1. The sensitivity metric may indicate, inter alia, a maximum separation that can occur between the sensor 610 and source 620 without detection of a tamper event.

In the FIG. 7B example, the device 102 may be separated from the external component 104 by a separation distance 712 of about the margin 732, such that dₙₒₘ+dₛₑₚ≥dₜₕ. Therefore, the magnetic field strength detected by the sensor 610 in the FIG. 7B example may fail to satisfy the magnetic field strength threshold (Gₜₕ) and, as such, the sensor 610 may trigger detection of a tamper event. The distance 712 may, therefore, comprise and/or be referred to as a trigger distance 712, or the like.

In some implementations, trigger criteria of the anti-tamper circuitry 110 may be configured in accordance with potential variance of the electromagnetic coupling 114-1 (coupling variance). As used herein, “coupling variance” may comprise and/or refer to variance exhibited in implementations of the electromagnetic coupling 114-1 due to, inter alia, manufacturing tolerances, environmental conditions (e.g., thermal expansion), and/or the like. Coupling variance may comprise and/or refer to variance pertaining to the sensor 610 (sensor variance), the source 620 (source variance), and so on. As used herein, “sensor variance” may comprise and/or refer to variance pertaining to the sensor 610 of the electromagnetic coupling 114-1, such as variance in the sensor position 612, sensor orientation 613, sensor accuracy, and/or the like. As used herein, “source variance” may comprise and/or refer to variance pertaining to the source 620 of the magnetic field 614 of the electromagnetic coupling 114-1, such as variance in the source position 622, source orientation (e.g., magnetic field orientation 615), strength of the magnetic field 614 produced by the source 620, and/or the like.

Coupling variance may impact the trigger distance 712 at which tamper events are detected. Coupling variance may be modeled in terms of the magnetic field strength threshold. For example, the actual magnetic field strength threshold (G_{th_actual}) of a particular implementation of the disclosed anti-tamper system 602 may be expressed as G_{th_actual}=Gₜₕ+Gᵥₐᵣ, where Gᵥₐᵣ is a measure of coupling variance, which may be modeled as a sum of sensor variance (G_{var_sens}) and source variance (G_{var_src}), e.g., Gᵥₐᵣ=G_{var_sens}+G_{var_src}.

Coupling variance may impact the separation or trigger distance 712 at which tamper events are detected. For example, variation in positions 612 and/or 622 may impact distance between the sensor 610 from the source 620 under nominal conditions, e.g., impact the nominal distance 710. The actual or effective nominal distance 710 (d_{nom_actual}) of a particular implementation of the disclosed anti-tamper system 602 may be modeled as, d_{nom_actual}=dₙₒₘ+d_{v_sens}+d_{v_src}, where dₙₒₘ is the default nominal distance, d_{v_sens} is configured to model sensor variance (e.g., variance of sensor position 612, sensor orientation 613, sensor accuracy, and/or the like), and d_{v_src} is configured to model the impact of source variance (e.g., variance of source position 622, strength of the magnetic field 614 produced by the source 620, magnetic field orientation 615, and/or the like).

FIG. 7C illustrates another example of an anti-tamper system 602. FIGS. 7C and 7D illustrate impact of coupling variance and, more specifically, a boundary or edge case exhibiting maximum weakening variance. As used herein, weakening variance (WV) refers to variance that reduces the strength of the magnetic field detected by the sensor 610 under nominal conditions. WV may comprise and/or refer to variance resulting in greater separation between the sensor 610 and source 620, misalignment between the orientation of the sensor 610 and source 620, lower sensor sensitivity, lower magnetic field strength, and/or the like. The electromagnetic coupling 114-1 illustrated in FIG. 7C may exhibit maximum WV and, as such, may comprise and/or be referred to as a maximum WV (or high WV) electromagnetic coupling 114-1-WV. Anti-tamper systems 602 comprising electromagnetic couplings 114-1-WV exhibiting high degrees of WV may comprise and/or be referred to as high-sensitivity, or high-WV anti-tamper systems 602-WV.

In the FIG. 7C example, the sensor 610 may be separated from the source 620 by a maximum nominal distance 710-MAX (d_{nom_max}). The maximum nominal distance 710-MAX (d_{nom_max}) may be modeled as a combination of the default nominal distance 710 (dₙₒₘ) and an additional separation distance corresponding to the maximum weakening variance (d_{wv_max}) exhibited by the system 602-MIN. As illustrated in FIG. 7C, maximum WV (d_{wv_max}) may comprise a sum of maximum sensor WV 734 (d_{sens_wv_max}) and maximum source WV 736 (d_{src_wv_max}), as follows:

$${d}_{nom \_ max} = {d}_{n o m} + {d}_{sens \_ wv \_ max} + {d}_{src \_ wv \_ max} \qquad Eq . 4$$

The maximum sensor WV 734 (d_{sens_wv_max}) quantity may correspond to a maximum variance in the sensor position 612 away from the source 620, maximum misalignment of the sensor orientation 613 relative to the magnetic field orientation 615, minimum sensor sensitivity, and/or the like. The maximum source WV 736 (d_{src_wv_max}) quantity may correspond to a maximum variance in the sensor position 612 way from the sensor 610, maximum misalignment of the magnetic field orientation 615 relative to the sensor orientation 613, minimum strength magnetic field 614, and/or the like.

As disclosed herein, trigger criteria of the anti-tamper system 602 may be expressed in terms of electromagnetic field strength detected at the sensor 610, e.g., trigger←Gₛ≤Gₜₕ. The trigger criteria may be expressed in terms of threshold distance 730 (dₜₕ, where Gₜₕ=Gₛ(dₜₕ)). In some implementations, aspects of the trigger criteria may be configured in accordance with variance characteristics of the anti-tamper system 602. As disclosed above, the distance threshold 730 may comprise a sum of the default nominal distance 710 and a margin 732, e.g., dₜₕ=dₙₒₘ+d_{mgn} per Eq. 3. As illustrated in FIG. 7C, the margin 732 (d_{mgn}) of the distance threshold 730 (dₜₕ) may incorporate the maximum weakening sensor variance 734 (d_{sens_wv_max}) and/or the maximum weakening source variance 736 (d_{src_wv_max}) of the anti-tamper system 602, as follows:

$$trigger ← {d}_{s e p} \geq {d}_{th} \qquad Eq . 5$$

$${d}_{th} = {d}_{n o m} + {d}_{sens \_ wv \_ max} + {d}_{src \_ wv \_ max} + {d}_{s f}$$

As illustrated in Eq. 5, the threshold distance 730 (dₜₕ) may be based, at least in part, on a sum of the default nominal distance 710 (dₙₒₘ), maximum weakening sensor variance 734 (d_{sens_wv_max}), maximum weakening source variance 736 (d_{src_wv_max}), and a sensitivity factor 738 (d_{sf}). Per Eq. 4 and 5 (and as illustrated in FIG. 7C), the maximum nominal distance 710-MAX (d_{nom_max}) may differ from the threshold distance 730 (dₜₕ) by the sensitivity factor 738, e.g., dₜₕ−d_{nom_max}=d_{sf}. The sensitivity factor (d_{sf}) may be configured to prevent the anti-tamper system 602-MIN from detecting false positives due to, inter alia, sensor jitter, transient error, environmental conditions (e.g., thermal expansion), and/or the like.

FIG. 7D illustrates another example of an anti-tamper system 602-WV exhibiting maximum weakening variance. In the FIG. 7D example, the device 102 may be displaced from the external component 104 by a minimum trigger distance 712-MIN. The displacement may result in corresponding separation between the sensor 610 and source 620. The minimum trigger distance 712-MIN (dₛₑₚ min) may be a distance approximately equivalent to the sensitivity factor 738 (d_{sf}), as disclosed herein. As illustrated in FIG. 7D, the sensor 610 may be separated from the source 620 by at least the threshold distance 730 (dₜₕ), which may result in detection of a tamper event by the sensor 610 and/or anti-tamper circuitry 110, e.g., d_{trigger_min}˜d_{sf}, such that d_{nom_max}+d_{trigger_min}>dₜₕ.

As illustrated above, anti-tamper systems 602 having higher degrees of WV may be more sensitive to tamper events than other anti-tamper systems 602. For example, the anti-tamper system 602-WV of FIG. 7D exhibits maximum WV and, as such, may trigger detection of tamper events in response to separation by a minimum trigger distance 712-MIN (d_{trigger_min}). In other words, anti-tamper systems 602-WV exhibiting higher degrees of WV may trigger detection of tamper events a lower separation distances than systems 602 having lower degrees of WV and/or systems 602 exhibiting strengthening variance, such as the anti-tamper system 602-SV illustrated in FIGS. 7E and 7F.

FIG. 7E illustrates an example of an anti-tamper system 602 exhibiting maximum strengthening variance. As used herein, strengthening variance (SV) refers to variance that tends to increase the strength of the magnetic field detected by the sensor 610 under nominal conditions. SV may comprise and/or refer to variance resulting in greater proximity (and/or lower separation) between the sensor 610 and source 620, high sensor sensitivity, high magnetic field strength, and/or the like. The electromagnetic coupling 114-1 illustrated in FIG. 7E may exhibit maximum SV and, as such, may comprise and/or be referred to as a maximum SV (or high SV) electromagnetic coupling 114-1-SV. Anti-tamper systems 602 comprising electromagnetic couplings 114-1-SV exhibiting high degrees of SV may comprise and/or be referred to as low-sensitivity, or high-SV anti-tamper systems 602-SV.

In the FIG. 7E example, the sensor 610 may be separated from the source 620 by a minimum nominal distance 710-MIN (d_{nom_min}). The minimum nominal distance 710-MIN (d_{nom_min}) may be modeled as a combination of the default nominal distance 710 (dₙₒₘ) less a distance corresponding to maximum SV (d_{v_smax}) exhibited by the system 602-SV. As illustrated in FIG. 7E, the maximum SV (d_{sv_max}) may comprise a sum of maximum sensor SV 735 (d_{sens_sv_max}) and maximum source SV 737 (d_{src_sv_max}), as follows:

$${d}_{nom \_ min} = {d}_{n o m} - ( {d}_{sens \_ sv \_ max} + {d}_{src \_ sv \_ max} ) \qquad Eq . 6$$

The maximum sensor SV 735 (d_{sens_sv_max}) quantity may correspond to a maximum variance in the sensor position 612 towards the source 620, maximum sensor sensitivity, and/or the like. The maximum source SV 737 (d_{src_sv_max}) quantity may correspond to a maximum variance in the sensor position 612 towards the source 620, maximum strength magnetic field 614, and/or the like.

As disclosed herein, the trigger criteria used to detect tamper events may incorporate characteristics of the coupling variance exhibited by the anti-tamper system 602. For example, the distance threshold 730 (dₜₕ) may comprise a sum of the default nominal distance 710 (dₙₒₘ), maximum sensor WV 734 (d_{sens_wv_max}), maximum source WV 736 (d_{sens_wv_max}), and a sensitivity factor 738 (d_{sf}). The high-level of SV exhibited electromagnetic coupling 114-1-SV may render the anti-tamper system 602-SV less sensitive to separation-related tamper events. In other words, the separation distance required to trigger tamper events may be greater for high SV anti-tamper systems 602-SV than in lower SV and/or higher WV anti-tamper system 602-WV.

FIG. 7F illustrates an example of an anti-tamper system 602-SV under non-nominal conditions, e.g., conditions indicative of a tamper event. As disclosed herein, anti-tamper systems 602 exhibiting lower levels of WV (and/or levels of SV) may be less sensitive to separation-related tampering. An anti-tamper system 602-SV exhibiting maximum SV may detect separation-related tampering in response to separation of the device 102 from the external component 104 by at least a maximum trigger distance 712-MAX (d_{trigger_max}). The maximum trigger distance 712-MAX (d_{trigger_max}) may comprise a difference between the threshold distance 730 (dₜₕ) and the minimum nominal distance 710-MIN (d_{nom_min}) separating the sensor 610 from the source 620 in the nominal configuration illustrated in FIG. 7E. The maximum trigger distance 712-MAX (d_{trigger_max}) may be modeled as:

$${d}_{trigger \_ max} = {d}_{wv \_ max} + {d}_{sv \_ max} + {d}_{s f} \qquad Eq . 7$$

The maximum WV (d_{wv_max}) may comprise a sum of maximum sensor WV 734 (d_{sens_wv_max}) and maximum source WV 736 (d_{src_wv_max}) and the maximum SV quantity may comprise a sum of maximum sensor SV 735 (d_{sens_sv_max}) and maximum source SV 737 (d_{src_sv_max}). Alternatively, the maximum trigger distance 712-MAX may be expressed as 2·d_{v_max} where the magnitude of maximum WV and SV are substantially equivalent.

Referring back to FIG. 7A, the sensitivity of the anti-tamper system 602 to separation events may be quantified by a sensitivity metric. The sensitivity metric may be based on the trigger distance 712 at which separation-related tamper events are detected. In some implementations, the sensitivity metric may be based on a range or distribution of trigger distances 712, e.g., from the minimum trigger distance 712-MIN of maximum WV implementations to the maximum trigger distance 712-MAX of maximum SV implementations. Alternatively, or in addition, the sensitivity metric may be based on the maximum trigger distance 712-MAX exhibited by implementations having high levels of SV, such as the anti-tamper system 602-SV illustrated in FIGS. 7E and 7F.

In some implementations, the anti-tamper system 602 may be configured to satisfy a maximum separation threshold. The maximum separation threshold may comprise and/or refer to a maximum separation between the device 102 and external component 104 (and/or sensor 610 and source 620) without triggering detection of a tamper event. The maximum separation threshold may correspond to the trigger distance 712 of the system 602. For example, the anti-tamper system 602 may be configured such that the maximum trigger distance 712-MAX satisfies the maximum separation threshold. As disclosed herein, the maximum trigger distance 712-MAX (and maximum separation threshold) may be a function of maximum coupling variance, e.g., per Eq. 7 above. Therefore, the maximum separation threshold may be controlled by controlling sensor and/or source variance. In other words, the sensor 610, source 620, and/or corresponding tolerances may be configured to satisfy a specified maximum separation threshold. Sensor variance (e.g., maximum sensor MV 734 and/or SV 735) may be controlled based, at least in part, on characteristics of the sensor 610, tolerances of the sensor position 612 (and/or sensor orientation 613), and so on. Source variance (e.g., maximum source MV 736 and/or SV 737) may be controlled based on characteristics of the source 620, tolerances of the source position 622 (and/or resulting magnetic field orientation 615), and so on. The sensitivity factor 738 may be configured to prevent false positives in high WV (and/or low strengthening variance) implementations. The sensitivity factor 738 may, for example, be determined based on testing and experience.

Although FIGS. 7A-7F illustrate examples of various distances (e.g., displacement distances, margins, variances, and/or the like), the disclosure is not limited in this regard. Moreover, the distance quantities illustrated in FIGS. 7A-7F are not to scale. For example, variance due to, inter alia, sensor position 612, sensor accuracy, source position 622, magnetic field strength, magnetic field orientation, and so on, are exaggerated in FIG. 7A-7F to highlight aspects of the illustrated examples.

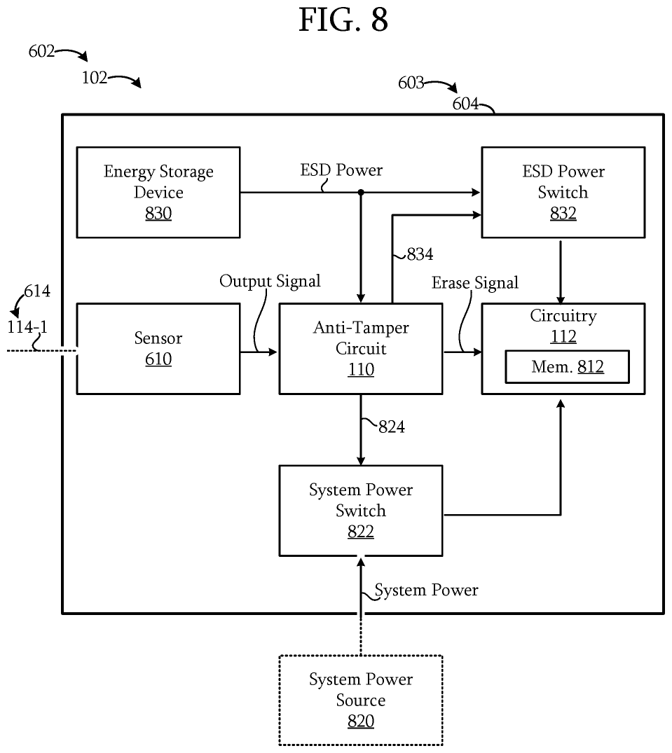

FIG. 8 is a schematic block diagram of another example of an anti-tamper system 602 comprising an electromagnetic coupling 114-1. FIG. 8 illustrates aspects of an anti-tamper device 102 of the system 602 (aspects of the anti-tamper system 602 disposed within the external component 104 omitted from FIG. 8 to avoid obscuring aspects of the illustrated example).

The device 102 may comprise an anti-tamper circuitry 110. The anti-tamper circuit 110 may be configured to detect tamper events pertaining to an electromagnetic coupling 114-1. Aspects of the electromagnetic coupling 114-1 may comprise and/or be implemented by a sensor 610. The sensor 610 may be configured to detect a magnetic field 614 generated by a source 620 disposed within an external component 104. The sensor 610 may be configured to trigger detection of a tamper event in response interruption of the electromagnetic coupling 114-1, e.g., in response to a strength of the magnetic field 614 detected at the sensor 610 failing to satisfy a threshold (Gₜₕ).

In some implementations, the anti-tamper device 102 may be further configured to detect and/or prevent spoof attacks. For example, in some implementations, the sensor 610 may be configured to detect magnetic fields 614 having a designated orientation (per a designated sensor orientation 613) and, as such, may ignore other, spoof magnetic fields 614S having other orientations, e.g., may comprise a unipolar device or the like. Alternatively, or in addition, the anti-tamper device 102 of the FIG. 8 example, may comprise other spoof detection means, which may include, but is not limited to: shielding 618 (e.g., means for shielding the sensor 610 from magnetic fields 614S other than the magnetic field 614 of the electromagnetic coupling 114-1), one or more secondary sensors 610S configured to trigger tamper events in response to detection of spoof magnetic fields 614S), and/or the like.

As illustrated in FIG. 8, the sensor 610 may be configured to generate an output signal. The output signal may indicate a status of the electromagnetic coupling 114-1. For example, the sensor 610 may maintain the output signal in a LOW, nominal state while the magnetic field 614 of the electromagnetic coupling 114-1 is detected (e.g., while Gₛ>Gₜₕ) and may assert the output signal to trigger detection of a tamper event in response to interruption of the electromagnetic coupling 114-1 (e.g., in response to Gₛ≤Gₜₕ).

The anti-tamper circuitry 110 may be configured to implement one or more mitigation actions in response to detection of a tamper event. The mitigation actions may comprise disabling authentication or other functions, deleting configuration information, disabling functionality of the circuitry 112, generating a tamper notification 601, and/or the like. The mitigation actions may comprise disabling at least one function of the circuitry 112 such that the at least one function remains disabled in response to clearance of the tamper event. In the FIG. 8 example, the mitigation actions may comprise asserting an erase signal, the erase signal configured to cause the circuitry 112 to erase data stored within a memory 812. The data erased from the memory 812 in response to detection of a tamper event may comprise information pertaining to operation of the external component 104. Erasing data from the memory 812 may be configured to disable at least one function of the circuitry 112. The at least function may remain disabled until the data is restored (e.g., reprogrammed into the memory 812), regardless of whether the tamper event is subsequently cleared.

In some implementations, aspects of the anti-tamper device 102 may comprise and/or be coupled to one or more power sources. In the FIG. 8 example, the device 102 may comprise and/or be coupled to a system power source 820 and an energy storage device (ESD) 830. The ESD 830 may comprise any suitable energy storage means including, but not limited to: a battery, capacitor, a supercapacitor, and/or the like. The ESD 830 may be configured to supply an ESD power signal to components of the anti-tamper device 102, such as the anti-tamper circuitry 110, sensor 610, and so on.

The circuitry 112 may be coupled the system power source 820 through, inter alia, a system power switch 822 and may be coupled to the ESD 830 through an ESD power switch 832. The anti-tamper circuitry 110 may be configured to control switches 822 and 832 by use of a system power enable (SPE) signal 824 and ESD power enable (EPE) signal 834. Under nominal conditions, the anti-tamper circuitry 110 may be configured to couple the circuitry 112 to system power; the anti-tamper circuitry 110 may be configured to enable the system power switch 822 (e.g., assert the SPE signal 824) and/or disable the ESD power switch 832 (e.g., disable the EPE signal 834). The anti-tamper circuitry 110 may be further configured to disconnect the circuitry 112 from system power in response to detection of a tamper event. In other words, the mitigation actions implemented by the anti-tamper circuitry 110 in response to detection of a tamper event may comprise a) disconnecting the circuitry 112 from system power (e.g., disabling the SPE signal 824) and/or b) connecting the circuitry 112 to the ESD 830 (e.g., asserting the EPE signal 834).

In some implementations, aspects of the anti-tamper device 102 may be physically coupled (e.g., may comprise a physical coupling 603). For example, one or more of the anti-tamper circuitry 110, circuitry 112, sensor 610, system power switch 822, ESD 830, and/or ESD power switch 832 may comprise and/or be disposed or implemented on a same circuit structure 604 such as a PCB or the like. The disclosure is not limited in this regard, however, and may be adapted to implement aspects of the anti-tamper device 102 illustrated in FIG. 8 separately, e.g., on other structures, other PCB, and/or the like.

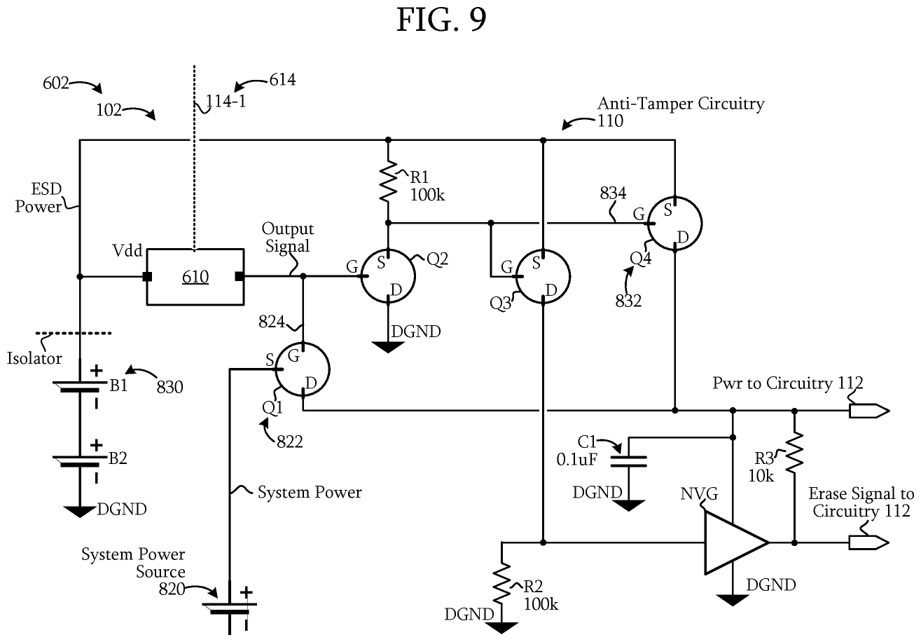

FIG. 9 is a circuit diagram illustrating another example of an anti-tamper device 102. FIG. 9 illustrates further aspects of the anti-tamper device 102 of FIG. 8. In the FIG. 9 example, the ESD 830 may comprise batteries B1 and B2 connected in series. The ESD 830 may be configured to produce an ESD power signal at a potential of about 3.3 volts. The ESD 830 may be coupled to the sensor 610 and/or anti-tamper circuitry 110, as disclosed herein.

The sensor 610 may be configured to produce an output signal indicating a status of the electromagnetic coupling 114-1 of the anti-tamper system 602. The sensor 610 may maintain the output signal in a LOW, nominal state while the magnetic field strength detected thereby satisfies a threshold, e.g., while Gₛ>Gₜₕ. The sensor 610 may be configured to assert the output signal when specified trigger criteria are satisfied, e.g., trigger←Gₛ≤Gₜₕ.

The anti-tamper circuitry 110 may comprise an NMOS FET Q2 configured to invert the output signal produced by the sensor 610. In other words, Q2 may be ON when the output signal is HIGH (e.g., Gₛ≤Gₜₕ) and may be OFF otherwise. Q2 may be further configured to activate Q3. Q3 may comprise a PMOS FET configured to activate the erase signal in response to detection of a tamper event. For example, Q3 may be configured to activate the erase signal by pulling the input of a non-inverting gate (INV) high.

The anti-tamper device 102 may be further configured to switch the circuitry 112 to battery power in response to detection of a tamper event. In the FIG. 9 example, the system power switch 822 may comprise and/or be implemented by PMOS FET Q1 and the ESD power switch 832 may comprise and/or be implemented by PMOS FET Q4. The PMOS FETs Q1 and Q4 may have an opposite polarity such that, if one is ON (or enabled) the other is OFF (or disabled). Under nominal conditions, the output signal is maintained at a LOW state and, as such, Q1 may be ON (e.g., enabled by SPE signal 824) and Q4 may be OFF (e.g., disabled by EPE signal 834). Accordingly, when the magnetic field strength detected by the sensor 610 satisfies the threshold (Gₜₕ), the circuitry 112 is coupled to the system power source 820 and disconnected from the ESD 830. Alternatively, in response to detection of a trigger event, the sensor 610 may assert the output signal, such that Q1 is OFF (e.g., disabled by SPE signal 824) and Q4 is ON (e.g., enabled by the EPE signal 834 generated by Q2). Accordingly, detection of a tamper event may result in switching the circuitry 112 from the system power source 820 to the ESD 830 (along with assertion of the erase signal, as disclosed above).

As illustrated in FIG. 9, in some implementations, the anti-tamper circuitry 110 may comprise a removable isolator I. The isolator I may comprise a removable structure configured to disconnect the ESD 830 from the anti-tamper circuitry 110. When in place, the isolator I may prevent the anti-tamper circuitry 110 from detecting tamper events (and/or implementing corresponding mitigation actions, such as asserting the erase signal). The isolator I may be in place prior to installation of the device 102 on an external component 104 and may be removed thereafter, as disclosed herein.

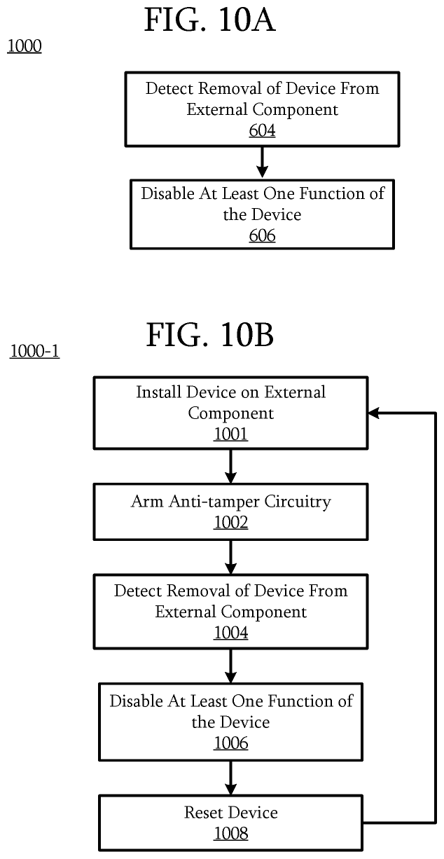

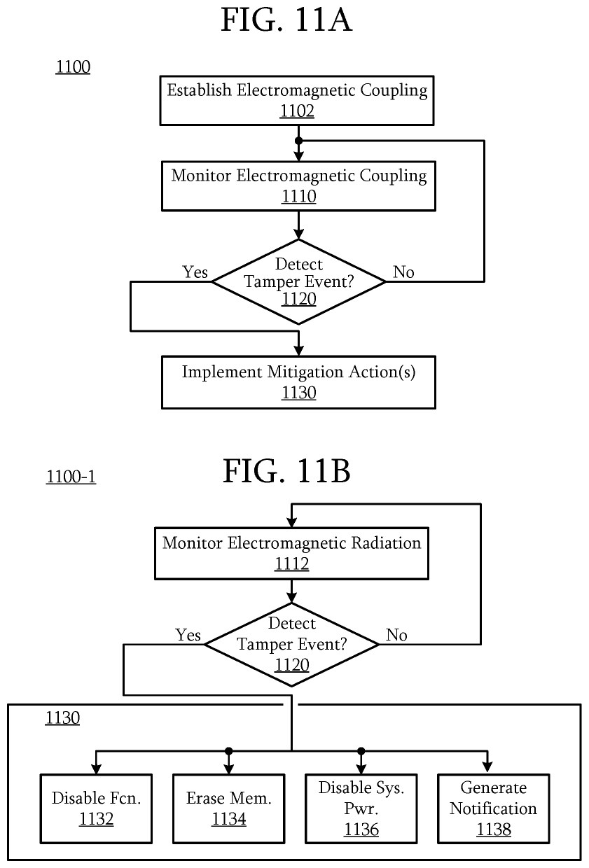

FIGS. 10A through 11B are flowcharts illustrating examples of methods for tamper detection and/or mitigation. Aspects of the disclosed methods may be implemented by examples of the anti-tamper devices 102 and/or anti-tamper systems 602 disclosed herein. Aspects of the disclosed methods may be implemented by hardware components, such as anti-tamper circuitry 110, switches, sensors 610, sources 620, and/or the like. Alternatively, or in addition, some aspects of the disclosed methods may be implemented and/or embodied by computer-readable instructions stored on non-transitory storage media, e.g., may be implemented and/or embodied by computer code, instructions, firmware, software, and/or the like.

FIGS. 10A and 10B are flowcharts illustrating examples of methods for anti-tamper detection (e.g., methods 1000 and 1000-1, respectively). FIGS. 10A and 10B, and the other flowcharts herein, illustrate techniques for operating an anti-tamper system 1002 (and/or device 102) comprising anti-tamper circuitry 110 according to some embodiments. Referring to FIG. 10A, in 1004 the removal of a device 102 from an external component 104 is detected. As described above, a variety of techniques may be used to detect the removal of the device 102. For example, the change in the state of a switch, the change in a magnetic field 614, the breaking of a circuit or the like may provide an indication of whether the device 102 is being removed from the external component 104.

In 1006, at least one function of the device 102 is disabled. As described above, the at least one function may be disabled by erasing data, disabling components, such as a processor, or the like. Various forms of the anti-tamper circuitry 110 may be used to perform the disabling.

In some embodiments, the detecting of the removal of the device 102 may include detecting the physical separation of structure of the device 102 and a structure of the external component 104. For example, the switch 220 may detect when device 102 is moved relative to the external component 104. Alternatively, or in addition, detecting removal of the device 102 may comprise monitoring an electromagnetic coupling 114-1. A tamper event may be triggered based on a strength of the magnetic field 614 detected by a sensor 610, e.g., may detect removal of the device at 1004 in response to Gₛ≤Gₜₕ, as disclosed herein.

Referring to FIG. 10B, in 1001, the device 102 is installed on the external component 104. For example, during authorized installation, replacement of a part, and/or maintenance of a system, a device 102 may be prepared and mounted on the external component 104. During installation, the anti-tamper circuitry 110 may be disarmed. For example, as described above, a removable isolator I such as an insulating tape may be disposed between the power supply 502 contacts and the disable circuit 504.

In 1002, the anti-tamper circuitry 110 may be armed. For example, once the device 102 is installed, the insulating tape may be removed, arming the anti-tamper circuitry 110. Before the insulating tape is removed, the device 102 may be mounted and removed repeatedly without engaging the anti-tamper circuitry 110. However, once removed, the anti-tamper circuitry 110 is armed and any attempt to remove the device 102 from the external component 104 may be detected and used to disable at least on function of the circuitry 112 of the device 102 in operations 1004 and 1006.

Once the anti-tamper circuitry 110 has been triggered and at least one function of the circuitry 112 has been disabled, the device 102 may be reset in 1008. Resetting the device 102 includes operations that return the device 102 to a state where it may again be installed or operated in an authorized manner. For example, the device 102 may be returned to an authorized repair facility. The erased data may be restored to the device 102, the disabled components may be reenabled, disabled components may be replaced, the isolator I described above may be reinstalled, or the like such that the device 102 is in a state similar to a device 102 that had not had the at least one function of the circuitry 112 disabled. Although returning the device 102 to an authorized repair facility has been used as an example, the resetting of the device 102 may be performed by an authorized repair technician with the appropriate data and/or components. An unauthorized party may not have the appropriate data and/or components and would not be able to restore the device 102 to an operating condition.

FIG. 11A is a flow diagram illustrating an example of a method 1100 for tamper detection. Aspects of the method 1100 (and/or other methods disclosed herein) may be implemented by the anti-tamper system 602 disclosed herein.

At 1102 an electromagnetic coupling 114-1 may be established between an external component 104 and circuitry 112 configured to control aspects of the operation of the external component 104. The circuitry 112 may be disposed within a device 102 configured to be attached to the external component 104. For example, the external component 104 may comprise an x-ray tube and the device 102 (and/or circuitry 112) may comprise a tube auxiliary unit.

In some implementations, the electromagnetic coupling 114-1 may comprise and/or be implemented by anti-tamper circuitry 110 disposed within the device 102. The anti-tamper circuitry 110 may comprise and/or be coupled to a sensor 610. The sensor 610 may be configured to detect a magnetic field 614 generated by a source 620 disposed within the external component 104. In some implementations, the sensor 610 may be shielded from external magnetic field energy. For example, the sensor 610 may be disposed within shielding 618 configured to block magnetic field energy other than magnetic field energy of the source 620.

The electromagnetic coupling 114-1 established at 1102 may be configured such that movement of the circuitry 112 relative to the external component 104 may result in corresponding movement of the anti-tamper circuitry 110 (and/or sensor 610) relative to the source 620, regardless of the structural integrity of the device 102, housing 116, external component 104, wall 124, housing 125, attachment means 117, and/or the like. The electromagnetic coupling 114-1 may be further configured such that movement of a protected component 608 relative to the circuitry 112 results in corresponding movement of the source 620 relative to the anti-tamper circuitry 110 (and/or sensor 610). The protected component 608 may comprise external component circuitry 120 and/or other internal element(s) of the external component 104, as illustrated in FIGS. 6C and 6D.

In some implementations, the electromagnetic coupling 114-1 established at 1102 may comprise a physical coupling 603 between the anti-tamper circuitry 110 (and/or sensor 610) and circuitry 112 configured to control the external component 104. For example, the device 102 may comprise a physical coupling 603 configured physically couple the circuitry 112 to the anti-tamper circuitry 110 (and/or sensor 610). The physical coupling 603 may be configured such that separation of the circuitry 112 from the external component 104 results in corresponding separation of the anti-tamper circuitry 110 (and/or sensor 610) from the external component 104 (and/or source 620). In other words, the physical coupling 603 may be configured such that separation of the circuitry 112 from the external component 104 results in corresponding separation of the anti-tamper circuitry 110 (and/or sensor 610) from the external component 104 (and/or source 620), regardless of the integrity of the device 102 and/or external component 104. In some implementations, the physical coupling 603 may comprise a circuit structure 604. For example, the anti-tamper circuitry 110, sensor 610, and/or circuitry 112 may be embodied, implemented, and/or disposed on a same circuit structure 604, such as a same PCB or the like.

The sensor 610 of the electromagnetic coupling 114-1 established at 1102 may be physically coupled to the external component 104. For example, the sensor 610 may be attached or embedded within a wall 124 or housing 125 of the external component 104. In some implementations, the electromagnetic coupling 114-1 established at 1102 may further comprise a physical coupling 605 between the source 620 and one or more protected components 608, as illustrated in FIGS. 6C and 6D. For example, the source 620 may be physically coupled to the external component circuitry 120, a component of an x-ray tube (e.g., an x-ray tube enclosure), and/or the like. The physical coupling 605 of the source 620 may be configured such that movement of a protected component 608 relative to the circuitry 112 results in corresponding movement of the source 620 relative to the anti-tamper circuitry 110 (and/or sensor 610), regardless of the structural integrity of the device 102, housing 116, external component 104, wall 124, housing 125, attachment means 117, and/or the like.

At 1110, the electromagnetic coupling 114-1 may be monitored. Aspects of the monitoring may be implemented by anti-tamper circuitry 110, as disclosed herein. The monitoring may comprise detecting a strength of the magnetic field 614 generated by the source 620 disposed within the external component 104 at the sensor 610 physically coupled to the circuitry 112. The monitoring may comprise detecting magnetic field energy at a designated orientation or polarity, as disclosed herein.

At 1120, a tamper event may be detected based, at least in part, on the monitoring at 1110. A tamper event may be detected in response to detecting an absence of the magnetic field 614 and/or in response to the magnetic field strength detected at the sensor 610 failing to satisfy a threshold, e.g., trigger←Gₛ≤Gₜₕ. If a tamper event is detected, the flow may continue at 1130; otherwise, monitoring may continue at 1110.

At 1130, one or more mitigation actions may be implemented in response to detection of the tamper event. The mitigation actions may include one or more of: disabling a function of the circuitry 112, erasing data from a memory of the circuitry 112, disabling system power to the circuitry 112 (and/or connecting the circuitry to an ESD, such as a battery), generating a tamper notification 601, transmitting the tamper notification 601 on an electronic communication network, and/or the like, as disclosed herein.

FIG. 11B is a flow diagram illustrating another method for tamper detection. At 1112, anti-tamper circuitry 110 may be configured to monitor electromagnetic radiation. The anti-tamper circuitry 110 may perform such monitoring by use of a sensor 610. The sensor 610 may be configured to detect a magnetic field 614 generated by a source 620 of an electromagnetic coupling 114-1.

In some implementations, the anti-tamper circuitry 110 may further comprise and/or be coupled to one or more secondary sensors 610S. The secondary sensors 610S may be configured to detect external, spoof magnetic fields 614S, e.g., detect magnetic field energy generated by spoof sources 620S.

At 1120, a tamper event may be detected based, at least in part, on the monitoring at 1112. Detection of the tamper event may be based on a magnetic field strength detected at the sensor 610, as disclosed herein. Alternatively, or in addition, a tamper event may be triggered in response to detection of a spoof magnetic field 614S by one or more secondary sensors 610S. A tamper event may be triggered in response to spoof criteria, as follows trigger←G_{spoof}≥G_{spoof_th}, where G_{spoof} is a magnetic field strength of a spoof magnetic field 614S detected by a secondary sensor 610S and G_{spoof_th} is a spoof detection threshold, which may be greater than the strength threshold, e.g., G_{spoof_th}<Gₜₕ. If a tamper event is detected at 1120, one or more mitigation actions may be implemented at 1130; otherwise, monitoring may continue at 1112.

At 1130, the mitigation actions implemented in response to detection of the tamper event may comprise asserting a tamper detection signal. The tamper detection signal may comprise and/or correspond to an output of the sensor 610 (and/or one or more secondary sensors 610S). The mitigation actions may include, but are not limited to one or more of: disabling at least one function of the circuitry 112 at 1132, erasing data from a memory of the circuitry 112 at 1134, disabling system power to the circuitry 112 (and/or coupling the circuitry 112 to an ESD) at 1136, generating a tamper notification 601 (and/or transmitting the tamper notification 601 over an electronic communication network) at 1138, and so on.

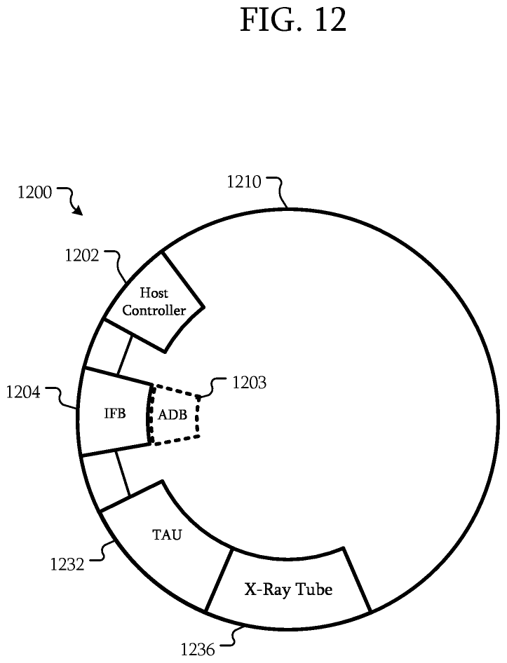

FIG. 12 is a block diagram of an x-ray system according to some embodiments. The x-ray system 1200 includes a host controller 1202, an interface board (IFB) 1204, and tube auxiliary unit (TAU) 1232, and an x-ray tube 1236. These components may be mounted on a rotatable gantry 1210.

In some embodiments, a device 102 is the IFB 1204 or is part of the IFB 1204. The external component 104 may be the gantry 1210. Thus, if the IFB 1204 is removed from the gantry, at least one function of the IFB 1204 may be disabled if the interface board is removed from the gantry 1210. The IFB 1204 may include firmware, software, calibration data, secret information such as keys, IDs, or other cryptographic information, or the like that may be erased to disable at least one function.

In some embodiments, a device 102 is an authentication daughter board (ADB) 1203 that is mounted on the IFB 1204. The external component 104 may be the IFB 1204. Information such as that described above may be erased if the ADB 1203 is removed from the IFB 1204.

In some embodiments, a device 102 is the TAU 1232. The TAU 1232 may be mounted on the x-ray tube 1236. The external component 104 may be the x-ray tube 1236. Thus, if the TAU 1232 is removed from the x-ray tube 1236, at least on function of the TAU 1232 may be disabled. The TAU 1232 may include data or firmware that may be erased similar to the IFB 1204 or ADB 1203.

In some embodiments, the host controller 1202 is configured to control operations of components such as the gantry 1210, the IFB 1204, the x-ray tube 1236 though the TAU 1232. While these components are used as examples, other components may be present such as an image detector, a high voltage (HV) generator, a heat exchanger, or the like. The host controller 1202 may also be configured to communicate with the IFB 1204 and perform various actions such as identification, authentication, or the like in addition to directing control of the system 1200.

As described above, in some embodiments the IFB 1204 includes the ADB 1203. This configuration may allow for easier retrofitting of the ADB 1203 to existing CT systems. The IFB 1204 has a communication link to the host controller 1202 and another communication link to the TAU 1232. The ADB 1203 contains cryptographic authentication hardware/firmware that allows for encrypted communication with both the host controller 1202 and the TAU 1232. The IFB 1204 is a device that holds the ADB 1203 and supplies power to it and translates the communications to a native communication protocol of the ADB 1203.

The TAU 1232 contains cryptographic authentication hardware/firmware that allows for encrypted communication with the IFB 1204/ADB 1203 and is attached to the x-ray tube 1236. When a hospital installs a new x-ray tube with its attached TAU 1232 the IFB 1204/ADB 1203 may challenge the TAU 1232 to see if it is a genuine manufacturer or OEM x-ray tube.

In some embodiments, the authentication unit of the TAU 1232 is mounted to the x-ray tube 1236, but the authentication unit could also be an integral part of the x-ray tube 1236. The anti-tamper circuitry 110 would be part of that authentication unit. Similarly, with other components such as an x-ray detector or imager, accelerator, or other device where it may be beneficial to render the unusable after its removal from its original installation location may include a device 102. Each of those may have associated anti-tamper circuitry 110.

In a particular example, the removal of a used x-ray tube, x-ray detector, or imager from an x-ray or mammography system for the purpose of resale into another system may be prevented. Upon removal of the device 102, a switch in the anti-tamper circuitry 110 would trigger and could disable the authentication function, render the firmware unusable, prevent communication, or any other essential function that would allow further usage of the device 102.

In some embodiments, the anti-tamper circuitry 110 could also be used to reinforce software/firmware (SW/FW) licensing of TAU 1232, x-ray tube 1236, detector, or other device software that was sold to a specific customer under a license agreement that would only allow the original buyer to utilize the firmware/software (FW/SW) or hardware. In such an embodiment, the respective FW/SW would be automatically erased when the device is removed.

While a CT system with a rotatable gantry 1210 has been used as an example of an x-ray system 1200, the x-ray system 1200 may take other forms.

Some embodiments relate generally to mechanisms, methods, and systems using a system identifier (ID) (or a device ID) in an encrypted form to a component.

In some embodiments, the mechanisms, methods, and systems described herein allows manufacturers or OEMs to detect unauthorized installation of components into their system. Currently, third-party suppliers can swap components on a system against used OEM components or third-party components which can lead to warranty issues, quality issues, and, in the case of an imaging system, image quality issues, diagnostic issues, and misdiagnosis. Embodiments described herein allow for the detection of such unauthorized component changes to ensure the integrity of the system.

Without a system such as those described herein, third parties can buy used components and sell them back to customers and undercut OEM service contracts. In contrast, embodiments described herein allow OEM host systems to determine if their components are being swapped without their permission and/or prevent installation of old, outdated or compromised component into a system that may affect operation, such as replacing a component in an imaging system that will affect the diagnosis of patients. Defective or not optimally functional components can lead to misdiagnosis and in extreme case can cause permanent harm to the patient and even death.

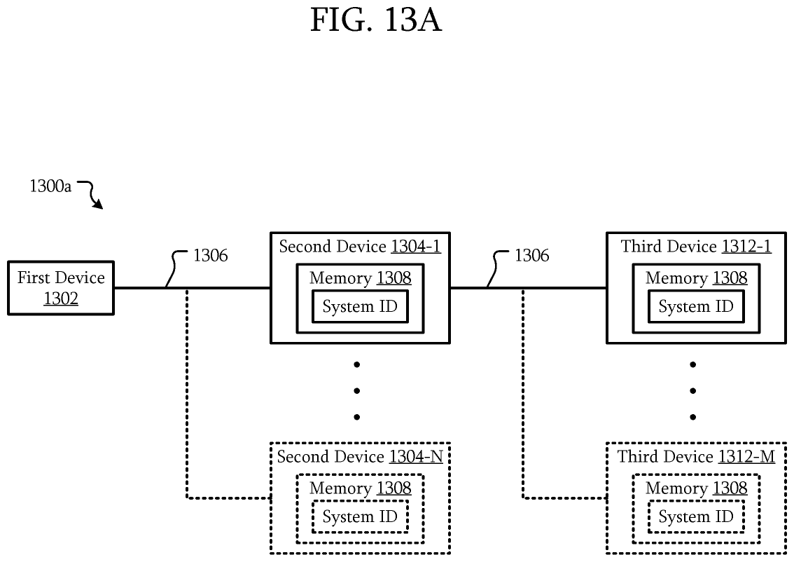

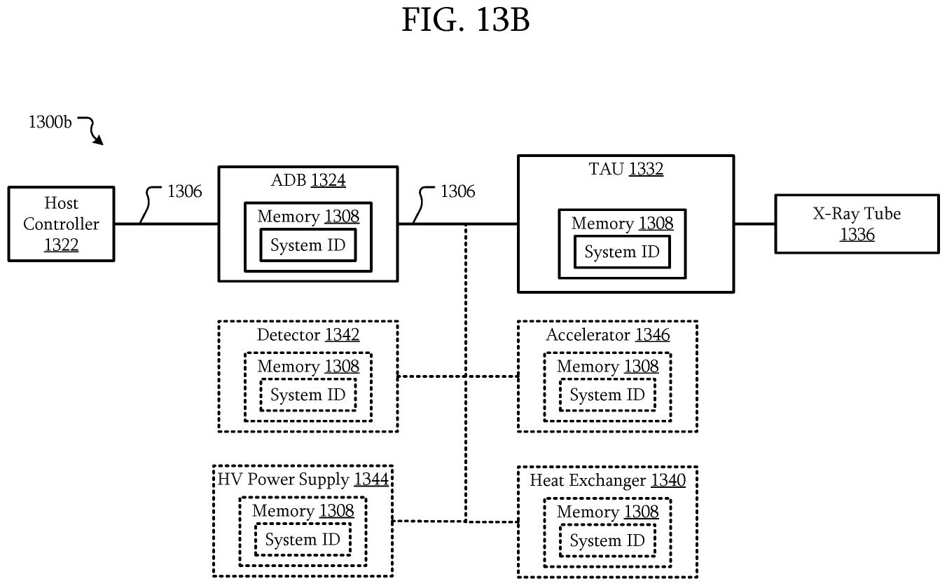

FIG. 13A-13B are block diagrams of systems including an authorization system according to some embodiments. Referring to FIG. 13A, the system 1300a includes a first device 1302 and a second device 1304. The devices 1302 and 1304 are coupled through a communication link 1306. The communication link may be any medium that allows the devices 1302 and 1304 to communication. For example, the communication link 1306 may include a serial link, a parallel link, and automation communication link such as Modbus, CANbus, or the like, a computer bus such as peripheral component interconnect express (PCIe), nonvolatile memory express (NVMe), or the like, and/or a network such as an Ethernet network, a Fibre Channel network, or the like.

The second device 1304 includes a non-volatile memory 1308. The memory 1308 may include any variety of non-volatile memory such as static random access memory (SRAM), flash memory, electrically erasable programmable read only memory (EEPROM), magnetic storage, or the like. In particular, the memory 1308 includes at least a portion that is operable in a one-time-write manner. The memory 1308 may include other non-volatile memory that is not configured for one-time-writes and/or volatile memory such as a dynamic random access memory (DRAM), a double data rate synchronous dynamic random access memory (DDR SDRAM) according to various standards such as DDR, DDR2, DDR3, DDR4.

Being one-time-write means that the portion of the memory 1308 is writable once in a normal write operation. In some embodiments, the one-time write memory 1308 may not be erased by other means. As a result, to change a value stored in the memory 1308 would require replacing the memory 1308. However, in other embodiments, the portion of the memory 1308 may be erased by erasing the entire memory 1308.

The memory 1308 is configured to store a system identifier (ID) in the one-time-write portion. The system ID is an identifier associated with the system 1300a. The system ID may be unique to the system 1300a such as by being a universally unique ID (UUID) or globally unique ID (GUID). The system ID for all devices 1304 and 1312 may be the same. However, in other embodiments, the system ID for a particular device 1304 or 1312 may be unique to both the system 1300a and that device 1304 or 1312. In some embodiments, the system ID may include a portion unique to the system 1300a and a portion unique to the particular device 1304 or 1312, the particular type of device 1304 or 1312, or the like.

The value of the system ID may take a variety of forms. For example, the system ID may exist in an original form where the stored data is the system ID. However, in other examples, an encrypted form of the system ID, a hash of the system ID, or other representations of the system ID may be stored as the system ID and treated as such with appropriate decoding or other manipulation.

As will be described in further detail below, a system ID can be stored on devices 1304 in a system 1300a. The first device 1302 can verify that the system ID stored on the second device 1304 or third device 1312 matches the expected system ID such as a system ID associated with the system 1300a. A match of the system ID may indicate that the second device 1304 or third device 1312 is a genuine component intended and originally installed on the system 1300a. If the system ID does not match, the device 1304 or 1312 may have been provided or installed by an unauthorized party. As a result, swapping of devices from other systems of the same manufacturer or from a third party may be detected.

In some embodiments, the first device 1302 may be coupled to multiple second devices 1304-1 to 1304-N. Each second device 1304 may be coupled to zero to multiple third devices 1312-1 to 1312-M.

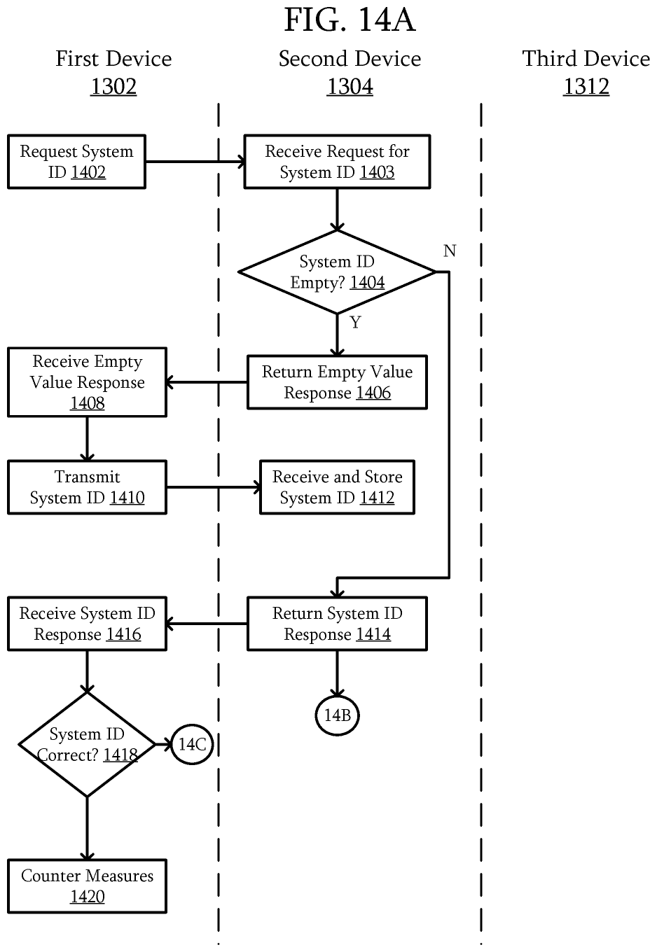

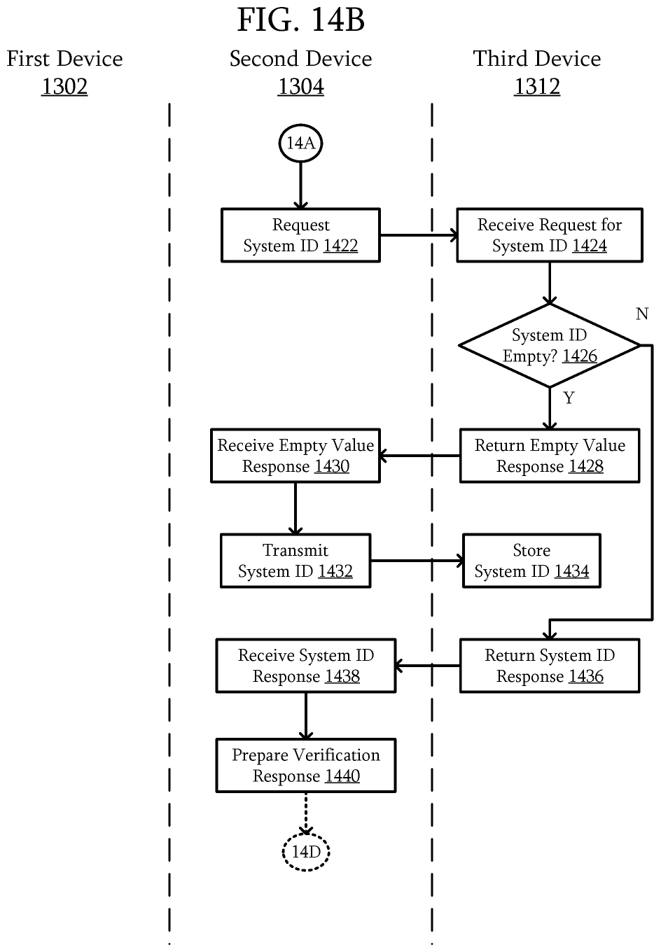

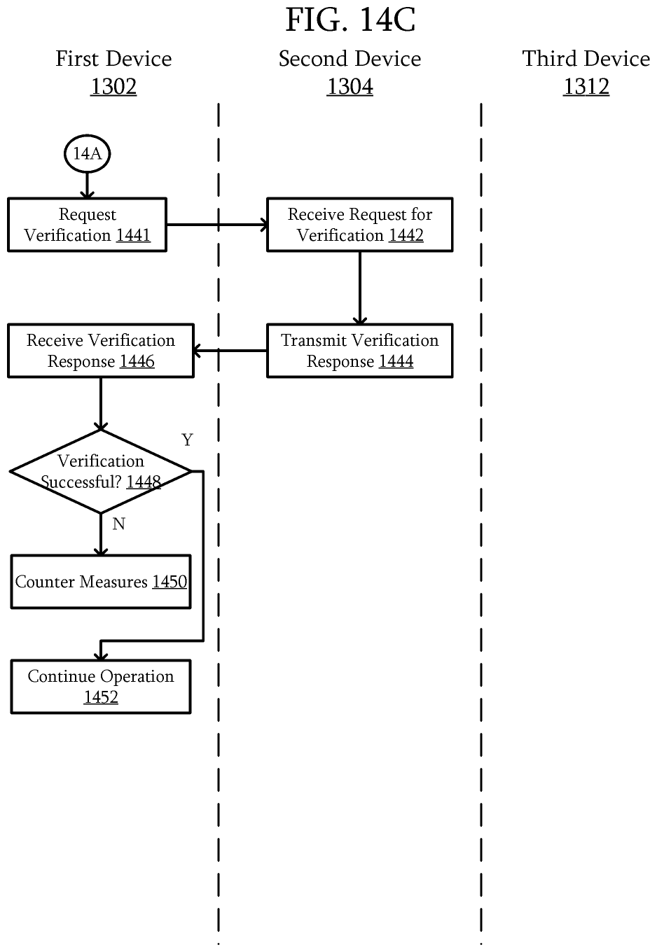

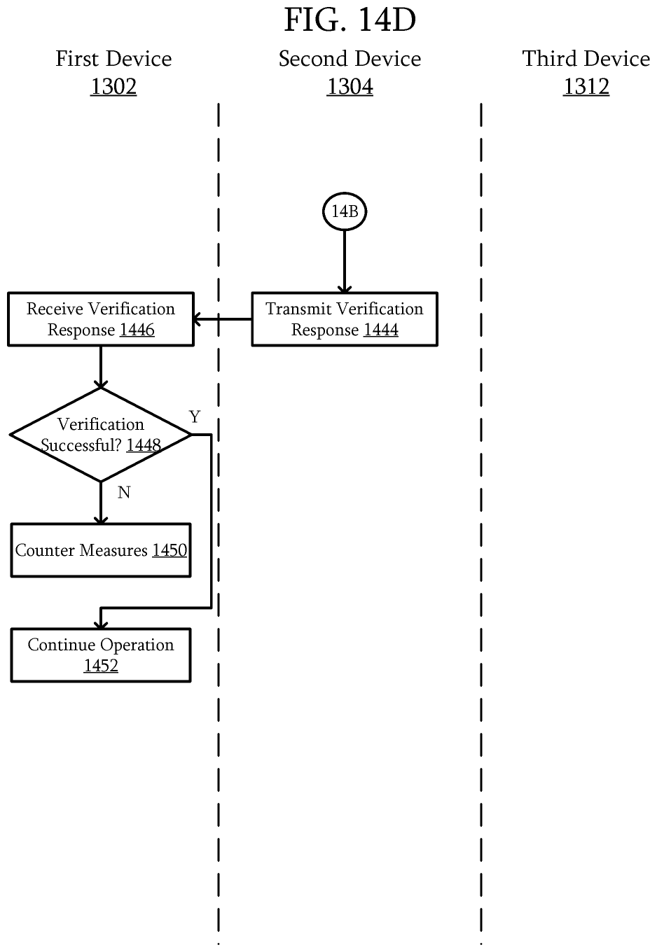

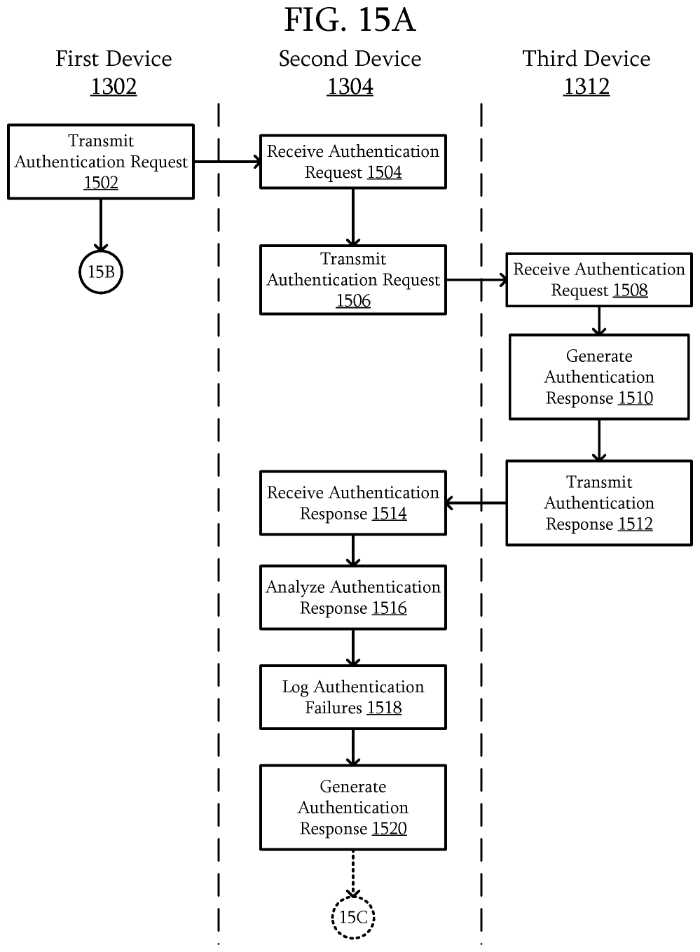

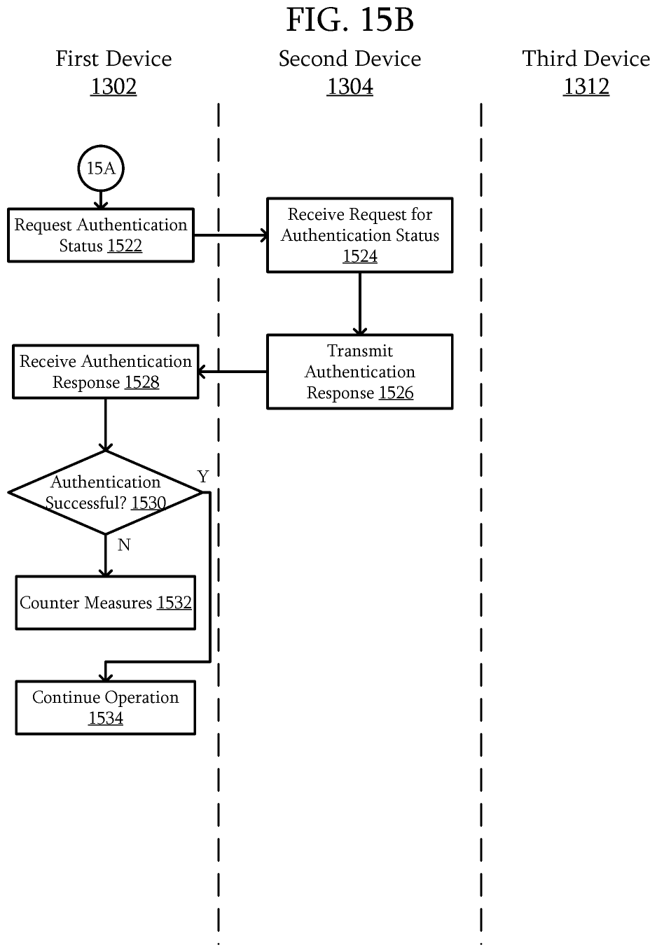

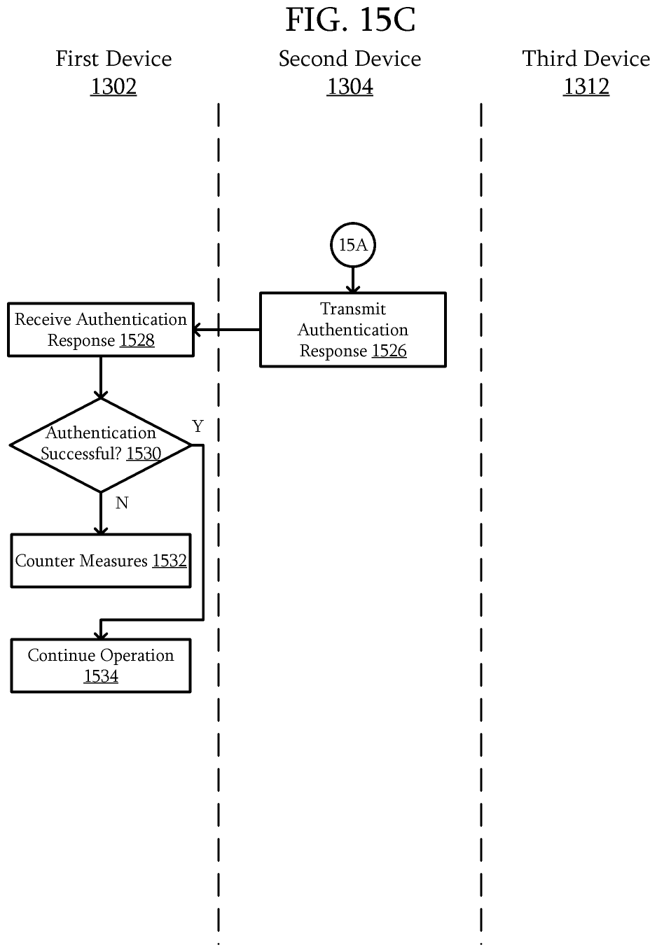

FIGS. 14A-15C are flowcharts showing examples of techniques of operating an authorization system according to some embodiments. In the following descriptions of techniques of operating the system, operations of a first device 1302, a second device 1304, and a third device 1312 of FIG. 13A will be used as examples.

Referring to FIGS. 13A and 14A, in 1402, the first device 1302 transmits a request for a system ID stored on the second device 1304 to the second device. The second device 1304 receives the request in 1403. This transmission and other similar operations may occur over the communication link 1306.

In 1404, the second device 1304 determines if the system ID stored on the second device has an empty value. The empty value represents a state where the second device 1304 has not stored a system ID in the memory 1308. An actual value may not be stored in the memory 1308. Instead, a flag, register, state, or the like may indicate that the system ID has not been programmed into the memory 1308. Checking such an indicator may be part of determining if the system ID has the empty value. A processor of the second device 1304 may be configured to attempt to read the system ID, flag, register, state, or the like to make the determination.

In 1406, a response based on the empty value is transmitted to the first device 1302. In some embodiments, the response may be a system ID that has a specific meaning. For example, all zeros or all ones may be designated as an empty value for the system ID. In other embodiments, a particular value or values of the system ID may be designated as the empty value. That specific value may be specific to the second device 1304 or the type of the second device 1304, specific to the system 1300a or the type of the system 1300a, or the like. Regardless, it is a value that the first device 1302 will recognize as indicating that the second device 1304 does not store a system ID or that the system ID is the empty value.

In other embodiments, the empty value response may be a different type of message from that used to transmit an actual system ID. For example, the empty value response may be an error message. The error message may have an error number or code that indicates that the system ID is empty.

In 1408, the empty value response is received by the first device 1302. In response, the first device 1302 transmits the system ID to the second device 1304 in 1410. The second device 1304 receives the system ID in 1412 and stores it in the one-time write portion of the memory 1308. Once the system ID is stored, the memory 1308 cannot be reprogrammed with a different system ID without extraordinary steps as described above. As a result, the second device 1304 is paired with the system 1300a. If the second device 1304 is removed from the system 1300a and placed in another system, even an identical system, the system ID may not match.

If the system ID is determined to be stored at the second device 1304 in 1404, a response based on the system ID is returned to the first device 1302 in 1414. For example, the second device 1304 may read the system ID, encrypt it, and transmit the encrypted system ID to the first device 1302.

The first device 1302 receives the response based on the system ID stored at the second device 1304 in 1416 and determines if the response indicates that the system ID stored at the second device 1304 matches the actual system ID in 1418. For example, the first device 1302 may extract the system ID by reading it from the response, decoding an encrypted response, or the like and comparing it to the system ID stored on the first device 1302. As described above, the system ID may be stored or encoded in a variety of formats. The comparison may be performed in a manner appropriate to the different formats.

If the system ID indicated by the response from the second device 1304 is not correct, if the second device 1304 does not respond or times out, if the second device 1304 returns an improper response, or the like, counter measures may be performed in 1420. The counter measures may take a variety of forms. For example, in some embodiments, the system 1300a may be shutdown, the devices 1302, 1304, 1312, or the like may be disabled temporarily or permanently, particular functions may be disabled, ranges of operation may be reduced or limited, or the like. In other embodiments, a notification, a warning, or other communication of the mismatched system IDs may be presented to a user of the system 1300a, reported over a network, or the like. In other embodiments, information related to the mismatching system IDs may be recorded in memory 1308 of the first device 1302 and/or the second device 1304. The related information may include a timestamp, model numbers and/or serial numbers of the first device 1302 and/or the second device 1304, number of times the system IDs had not matched, the mismatched system ID, the entire response received in 1416, or the like.

In some embodiments, when response based on the system ID is transmitted to the first device 1302 from the second device 1304 in 1414, the communication may be encrypted. For example, a secure communication link may be established between the first and second devices 1302 and 1304, the response or portions of it may be encrypted, the system ID stored on the second device 1304 may be encrypted, or the like. As a result, it may be more difficult for an eavesdropper to obtain the correct system ID response from the second device 1304.

The system 1300a may be a hierarchical system that includes a third device or devices 1312 that are downstream from an associated second device 1304. In some embodiments, some or all communication between the first device 1302 and the third device 1312 may pass through or be manipulated by the associated second device 1304. However, in other embodiments, only the communications related to the system ID may pass through or be manipulated by the associated second device 1304.

In some embodiments, the interactions between the second device 1304 and the third device 1312 may be the same or similar to the operations described with respect to the first device 1302 and the second device 1304. That is, once the second device 1304 stores the system ID, the requesting, storing if empty, and verifying of the system ID may be performed between the second and third devices 1304 and 1312.

Referring to FIGS. 13A, 14A, and 14B, in some embodiments, once the second device 1304 has transmitted the system ID response in 1414, the second device 1304 may begin the operations described above with respect to FIG. 14B. A request for the system ID stored on the third device 1312 may be transmitted in 1422 from the second device 1304 to the third device 1312. The third device 1312 may receive the request for the system ID stored on the third device 1312 in 1424. Similar to the operations in 1404 and 1406 of FIG. 14A, in 1426 and 1428, the third device 1312 may determine if the system ID is the empty value or has not been stored and, if so, return the empty value response. Similar to the operations in 1408 and 1410 of FIG. 14A, in 1430 and 1432, the second device 1304 receives the response indicating that the system ID stored on the third device 1312 has the empty value and transmits the system ID in response. In 1434, the third device 1312 stores the system ID in the memory 1308. Similar to the operations in 1414 and 1416, in 1436 and 1438, the third device 1312 may transmit a response based on the system ID stored on the third device 1312 and that response is received by the second device 1304. Although the operations of the second device 1304 and the third device 1312 have been described as being similar to those of the first device 1302 and second device 1304, in other embodiments, the operations may be different. For example, different encodings of the system ID, encryption used in transmission, format of responses, particular protocol, or the like may be used.

In 1440, the second device 1304 may prepare a verification response based on the responses from the third device 1312. In some embodiments, the verification response may include the system ID response from the third device 1312 itself. In other embodiments, the second device 1304 may determine if the system ID stored on the third device 1312 matches the system ID stored on the second device 1304 similar to the interaction of the first device 1302 in 1418 of FIG. 14A. The verification response may include an indication of whether the system ID stored on the third device 1312 is the correct system ID.

Referring to FIGS. 13A, and 14A-14C, in some embodiments, if the system ID stored on the second device 1304 is determined to be the correct system ID in 1418, the first device 1302 may transmit a verification request to the second device 1304 in 1441. In 1442, the second device 1304 receives the verification request. As described above, the second device 1304 may prepare a verification response in 1440. This verification response may be transmitted by the second device 1304 to the first device 1302 in 1444. In 1446, the first device 1302 receives the verification response and determines if the verification was successful in 1448 based on the response. If the verification was successful, operations continue in 1452.

However, if the verification was not successful, counter measures may be performed in 1450. The counter measures may be similar to those described with respect to 1420. However, as the verification response may be associated with the third device 1312, the counter measures may also apply to the third device 1312. For example, the third device 1312 may be disabled, a notification may be presented identifying the third device 1312, or the like.

Referring to FIGS. 13A, 14A, 14B, and 14D, in some embodiments, once the second device 1304 has prepared the verification response in 1440, the second device 1304 may transmit the verification response in 1444 to the first device 1302 without waiting for the request transmitted in 1441. The operations of the first device 1302 in 1446, 1448, 1450, and 1452 may be similar to those described above.

Although the operations of the first device 1302 and second device 1304 have been described in the context of communications between the first device 1302 and one second device, the same or similar communications may occur between the first device 1302 and multiple second devices 1304-1 to 1304-N. That is, the first device 1302 may request the system ID for each of the second devices 1304-1 to 1304-N and perform operations similar to those described above. The operations for different second devices 1304-1 to 1304-N may be performed serially or in parallel. Decisions may be based on responses of only one of the second devices 1304-1 to 1304-N, some of the second devices 1304-1 to 1304-N, or all of the second devices 1304-1 to 1304-N. The results of matching or mismatching system IDs may be the same, similar, or different for different second devices 1304-1 to 1304-N. The operations described between a second device 1304 and a third device 1312 may similarly be performed with multiple third devices 1312. Moreover, although a three-tier hierarchy has been used as an example, and hierarchy of devices may be part of the system 1300a where the first device 1302 queries other devices for a system ID.

Referring to FIG. 13B, in some embodiments, an x-ray system 1300b includes a host controller 1322, an ADB 1324, a TAU 1332, and an x-ray tube 1336. The host controller 1322 may be a system controller for the x-ray system 1300b. The host controller 1322 may act as the first device 1302 of FIG. 13A and perform the associated operations described in FIGS. 14A-D.

The ADB 1324 may be a circuit that manages the system ID and authentication operations of the system 1300b. The ADB 1324 may include a memory 1308. The ADB 1324 may act as the second device 1304 of FIG. 13A and perform the associated operations described in FIGS. 14A-D.

The TAU 1332 is a circuit configured to control the operation of the x-ray tube 1336. For example, the TAU 1332 may be configured to control cathode voltages/currents, anode voltages/currents, filament voltages/currents, focusing electronics, steering electronics, motors, or the like depending on the particular x-ray tube 1336. The TAU 1332 includes a memory 1308 and may act as the third device 1312 of FIG. 13A and perform the associated operations described in FIGS. 14A-D.

While the TAU 1332 has been used as an example of a device in an x-ray system 1300b that may operate using a system ID as described herein, other devices in an x-ray system 1300b may operate similarly. For example, a heat exchanger 1340, detector 1342, high voltage (HV) power supply, 1344, accelerator 1346, or the like may operate using a system ID as described herein.

In some embodiments, at initialization or installation, a system ID may be transmitted from the host controller 1322 to the ADB 1324 and stored in memory 1308. The ADB 1324 may similarly propagate the system ID to the other devices 1332, 1340, 1342, 1344, 1346, or the like for storage in corresponding memory 1308 of those devices. Thus, the devices of the system 1300b may be paired with that system 1300b. In normal operation, the devices will report the correct system ID and the system 1300b may continue operation. However, if a part is replaced in an unauthorized manner with a different, existing system ID, the counter measures described above may be performed.

In some embodiments, the host controller uses the ADB 1324 to communicate with the rest of the manufacturer or OEM's components in the system 1300b. In some embodiments the only components that are paired with the system 1300b are the ADB 1324 and the TAU 1332.

The use of the system ID as described herein in an x-ray system 1300b may improve safety and/or longevity of the system 1300b. In particular, the components of the system 1300b may be aligned, calibrated, or otherwise configured for that specific x-ray system 1300b. When the system 1300b is initially installed, the empty system IDs in the various devices of the x-ray system 1300b may be initialized to a system ID unique to that particular x-ray system 1300b. If a device in the x-ray system 1300b is replaced by a device from another system with a different system ID, the operation of the x-ray system 1300b may not be the same and, with devices such as the x-ray tube 1336, may become dangerous. As described above, the x-ray system 1300b may take counter measures when such a situation is detected, notifying a user, shutting down the x-ray system 1300b or a component, or the like. As a result, a chance that the x-ray system 1300b will be operated in a manner that may lead to erroneous results and/or dangerous operating conditions may be reduced or eliminated.

In some embodiments, the storage and verification of the system ID as described herein may limit a manufacturer or vendor's customer's ability to swap components themselves or through a third party. The verification process checks to see if the ADB 1324, TAU 1332, or the like is a genuine manufacturer or OEM product and that it hasn't been swapped to/from other x-ray systems. It prevents third party service organizations buying used x-ray tubes on the open market, refurbishing them and then selling them back to customers such as hospitals. A manufacturer, vendor, system integrator, or the like may reduce a chance that their system is modified with devices from other systems, which may lead to undesirable or dangerous results.

In some embodiments, use of the system ID as described herein may reduce a chance that a reworked device is installed in a system for which it was not intended. For example, a device that has been paired with a system and has a system ID may returned for repair, updates, or the like. The device may be programmed with the original system ID or the system ID may be left intact. As a result, when that device is supplied to a customer or installer, the system ID will match the system ID of the original system. If the device is installed in a different system, even if a similar system or the same type of system, the system ID will not match, and the counter measures described above may be performed. In some embodiments, the system ID may be left unprogrammed if a known customer or installer will reinstall the device in the same system.

Referring to FIGS. 13A and 14A-15C, in some embodiments, authentication operations may be performed after successful verification in 1448 described above. For example, in 1502, the first device 1302 transmits an authentication request to the second device 1304. In 1504, the authentication request is received by the second device 1304. The second device 1304 transmits an authentication request to the third device 1312 in 1506.

The third device 1312 receives the authentication request in 1508. In 1510, the third device generates an authentication response and transmits that authentication response to the second device 1304 in 1512.

The second device 1304 receives the authentication response from the third device 1312 in 1514. The second device 1304 analyzes the authentication response 1516, logs failures in 1518, and generates its own authentication response in 1520. The authentication response generated in 1520 may aggregate the authentication response or responses received from one or more third devices 1312 and the second device's 1304 own authentication response.

In 1522, the first device 1302 may transmit a request for the authentication status that is received by the second device in 1524 as illustrated in FIG. 15B. In response, the second device 1304 transmits the authentication response to the first device 1302 in 1526. Alternatively, the second device 1304 may transmit the authentication response to the first device 1302 in 1526 after generating it in 1520 as illustrated in FIGS. 15A and 15C.

Once the authentication response is received in 1528, the response may be analyzed to determine if the authentication is successful in 1530. If so, the operations may continue in 1534. If not, counter measures may be performed in 1532 similar to the counter measures described above.

A variety of different techniques may be used to authenticate the devices 1304 and 1312. In some embodiments, the authentication may be performed using a challenge using hidden numbers. An encryption algorithm may use an initialization vector (IV) and an encryption key (key). The first device 1302 and/or the second device 1304 may create a challenge (math problem) using its IV and key and sends it the downstream second device 1304 or third device 1312. If that device has the same key and IV then it may do the same math problem and get the same result. The second device 1304 or third device 1312 that was “challenged” may then send back the “answer” to that math problem in an encrypted form and the original component can make sure that it answered the challenge correctly. If it responded with the correct answer, then the first device 1302 and/or the second device 1304 may treat the corresponding second device 1304 or third device 1312 as a genuine part.

In some embodiments, the IV and the key are maintained in restricted memory of a cryptographic authentication integrated circuit. For example, an ATSHA integrated circuit may include such restricted memory and may be capable of performing calculations related to encrypted communications. The authentication operations may be more secure if the IV and key are stored in such restricted memory.

In some embodiments, the authentication process may be used to ensure that all required components are in the system, are designed for the particular customer, and/or are genuine manufacturer or OEM components. Different customers may have customer specific encryption keys so that a third party cannot take a component designed for one customer and sell it to another. Any missing components will fail the authentication process as they will not authenticate if they are not present. The authentication process may prevent a third party from supplying part of the system. If the full computed tomography (CT) system is designed to have 5 manufacturer or OEM components but only 4 of them are genuine and the fifth was sourced from a third party, the authentication process would identify that fifth component as not genuine.

As described above, more than one second device 1304 and more than one third device 1312 may be present in the system 1300a. The authentication with each of these as described with respect to the single second device 1304 and single third device 1312.

While the system 1300a of FIG. 13A was used as an example, the authentication operation operations described above with respect to FIGS. 15A-C may be implemented by other systems, such as the x-ray system 1300b of FIG. 13B.

Some embodiments include a device 102, comprising: a mounting structure configured to mount the device 102 to an external component 104; first circuitry 112; and anti-tamper circuitry electrically connected to the first circuitry 112 and configured to disable at least one function of the first circuitry 112 when the device 102 is removed from the external component 104. In some embodiments, the external component 104 may include a wall, housing, or other structure that is not controlled by the first circuitry 112.

In some embodiments, the first circuitry 112 is configured to control the external component 104. In some embodiments, the at least one function of the first circuitry 112 include functions that are not related to the control of the external component 104.

In some embodiments, the at least one function of the first circuitry 112 comprises functions of the first circuitry 112 that control the external component 104.

In some embodiments, the device 102 further comprises: a housing 116 coupled to the mounting structure wherein the housing 116 is configured to restrict access to disarm the anti-tamper circuitry when the device 102 is mounted to the external component 104.

In some embodiments, the anti-tamper circuitry 110 comprises: a switch 220 or SW1 coupled to the mounting structure (e.g., housing 116) and configured to switch when the device 102 is removed from the external component 104.

In some embodiments, the switch 220 or SW1 is configured to switch by a structure of the external component 104 when mounted on the external component 104.

In some embodiments, the anti-tamper circuitry 110 comprises: a power supply 502 disposed within the device 102 and configured to supply power after detecting removal of the device 102 from the external component 104; and a disable circuit 504 configured to disable the at least one function of the first circuitry 112; wherein the switch 220 or SW1 is configured to electrically connect the power supply 502 to the disable circuit 504 when the device 102 is removed from the external component 104.

In some embodiments, the first circuitry 112 includes a processor 113; and the anti-tamper circuitry 110 is configured to erase at least a portion of memory 118 or 1308 used by the processor 113 when the device 102 is removed from the external component 104.

In some embodiments, the at least a portion of memory 118 or 1308 used by the processor 113 comprises memory 118 or 1308 integrated with the processor 113.

In some embodiments, the at least a portion of memory 118 or 1308 used by the processor 113 stores cryptographic information.

In some embodiments, the device 102 is part of electronics associated with an x-ray system; and the external component 104 is an x-ray tube 1236 or 1336 of the x-ray system 1200 or 1300b.

In some embodiments, the device 102 is part of a component authentication system associated with an x-ray system 1200 or 1300b.

Some embodiments include a method, comprising: detecting, by a device 102, removal of the device 102 from a component 104 external to the device 102; and disabling at least one function of circuitry 112 of the device 102 in response to detecting the removal of the device 102 from the component 104.

In some embodiments, the detecting, by the device 102, removal of the device 102 from the component 104 comprises detecting physical separation of a structure of the device 102 and a structure of the component 104 external to the device 102.

In some embodiments, the disabling of at least one function of the circuitry 112 of the device 102 comprises: powering a disable circuit 504 from an internal power supply 502; and disabling the at least one function of the circuitry of the device 102 using the disable circuit 504.

In some embodiments, the detecting, by the device 102, removal of the device 102 from the component 104 comprises detecting physical separation of a structure of the device 102 and a structure of the component 104 external to the device 102.

In some embodiments, the method further comprises: installing the device 102 on the component 104; and arming anti-tamper circuitry 110 configured to disable to at least one function of the circuitry of the device 102.

In some embodiments, the method further comprises: resetting anti-tamper circuitry 110 configured to disable to at least one function of the circuitry 112 of the device 102.

Some embodiments include a device, comprising: means for detecting, by a device, removal of the device from a component external to the device; and means for disabling at least one function of circuitry of the device in response to the means for detecting the removal of the device from the component. Examples of the means for detecting include the anti-tamper circuitry 110, switch 220 or SW1, or the like. Examples of the means for disabling at least one function of circuitry of the device include the anti-tamper circuitry 110, the processor 113, the memory 118 or 1308, or the like.

In some embodiments, the device further comprises: means for detecting physical separation of the device from the component; and means for erasing at least part of memory of the circuitry in response to the means for detecting physical separation of the device 102 from the component. Examples of the means for detecting physical separation of the device from the component include the anti-tamper circuitry 110, switch 220 or SW1, or the like. Examples of the means for erasing at least part of memory of the circuitry comprise the anti-tamper circuitry 110, the processor 113, the memory 118 or 1308, or the like.

Some embodiments include a method, comprising: receiving from a first device 1302 at a second device 1304, a request for a system identifier (ID) stored on the second device 1304; determining, by the second device 1304, if the system ID stored on the second device 1304 has an empty value; and when the system ID stored on the second device 1304 does not have the empty value, transmitting, by the second device 1304 to the first device 1302, a response based on the system ID stored on the second device 1304.

In some embodiments, the method further comprises: when the system ID stored on the second device 1304 has the empty value, communicating, by the second device 1304 to the first device 1302, that the system ID stored on the second device 1304 has the empty value.

In some embodiments, the method further comprises: receiving, from the first device 1302 by the second device 1304, the system ID; and storing, by the second device 1304, the system ID received from the first device 1302 as the system ID stored on the second device 1304.

In some embodiments, storing, by the second device 1304, the system ID received from the first device 1302 as the system ID stored on the second device 1304 comprises storing, by the second device 1304, the system ID received from the first device 1302 in one-time-write memory 1308.

In some embodiments, transmitting, by the second device 1304 to the first device 1302, the response based on the system ID stored on the second device 1304 comprises encrypting the system ID stored on the second device 1304 and transmitting, by the second device 1304 to the first device 1302, the encrypted system ID.

In some embodiments, the method further comprises: transmitting, by the second device 1304 to a third device 1312, a request for a system ID stored on the third device 1312; and receiving, by the second device 1304 from the third device 1312, a response to the request for the system ID stored on the third device 1312.

In some embodiments, the method further comprises: transmitting, by the second device 1304 to the first device 1302, a response based on the response to the request for the system ID stored on the third device 1312.

In some embodiments, the method further comprises: determining, by the third device 1312, if the system ID stored on the third device 1312 has the empty value; and when the system ID stored on the third device 1312 has the empty value, communicating, by the third device 1312 to the second device 1304, that the system ID stored on the third device 1312 has the empty value.

In some embodiments, the method further comprises: storing, by the third device 1312, the system ID received from the second device 1304 as the system ID stored on the third device 1312.

In some embodiments, the second device 1304 is an authentication device for an x-ray system 1300b; and the third device 1312 is a control device for an x-ray tube 1336 of the x-ray system 1300b.

Some embodiments include a method, comprising: transmitting, from a first device 1302 to a second device 1304, a request for a system identifier (ID) stored on the second device 1304; receiving, from the second device 1304 by the first device 1302, a response to the request for the system ID stored on the second device 1304; determining, by the first device 1302, if the system ID stored on the second device 1304 is a correct system ID for a system including the second device 1304; and operating the system including the second device 1304, by the first device 1302, based on whether the system ID stored on the second device 1304 is the correct system ID for the system including the second device 1304.

In some embodiments, operating the system including the second device 1304 comprises enabling counter measures when the system ID stored on the second device 1304 is not the correct system ID for the system including the second device 1304.

In some embodiments, the counter measures comprise at least one of disabling the second device 1304, disabling the system including the second device 1304, presenting a warning that the system ID stored on the second device 1304 and the correct system ID for the system including the second device 1304 do not match to a user.

In some embodiments, operating the system including the second device 1304 comprises, when the system ID stored on the second device 1304 matches the correct system ID for the system including the second device 1304, transmitting, by the first device 1302 to the second device 1304, a request for verification of devices subordinate to the second device 1304.

In some embodiments, the method further comprises: receiving, by the first device 1302 from the second device 1304, a response to the request for verification of devices subordinate to the second device 1304; wherein operating the system including the second device 1304 comprises operating the system based on the response to the request for verification of at least one device subordinate to the second device 1304.

In some embodiments, the second device 1304 is an authentication device for an x-ray system 1300b; and the at least one device subordinate to the second device 1304 is a control device for an x-ray tube 1336 of the x-ray system 1300b.

In some embodiments, the method further comprises: transmitting, from the first device 1302 to the second device 1304, a request for authentication of the second device 1304; and receiving, by the first device 1302 from the second device 1304, a response to the request for authentication of the second device 1304; wherein operating the system including the second device 1304 comprises operating the system including the second device 1304 based on the response to the request for authentication of the second device 1304.

Some embodiments include a device, comprising: means for receiving, from a first external device, a request for a system identifier (ID) stored on the device; means for determining if the system ID stored on the device has an empty value; and means for transmitting, to the first device, a response based on the system ID stored on the device when the system ID stored on the device does not have the empty value. Examples of the means for receiving, from a first external device, a request for a system identifier and the means for transmitting, to the first device, a response based on the system ID include the second device 1304, the third device 1312 or the like.

In some embodiments, the device further comprises: means for transmitting, to a second external device, a request for a system ID stored on the second external device; and means for receiving, from the third device, a response to the request for the system ID stored on the second external device. Examples of the means for transmitting, to a second external device, a request for a system ID and the means for receiving, from the third device, a response to the request for the system ID include the second device 1304, the third device 1312 or the like.

Some embodiments include at least one non-transitory machine-readable storage medium comprising a plurality of instructions adapted to be executed to implement the method described above.

Some embodiments comprise a device 102 configured to be mounted to an external component, comprising: first circuitry 112 configured to control the external component; anti-tamper circuitry 110 electrically connected to the first circuitry 112; and an electromagnetic coupling 114-1 established between the anti-tamper circuitry 110 and a source 620 disposed within the external component 104; wherein the anti-tamper circuitry 110 is configured to disable at least one function of the first circuitry 112 in response to detecting a tamper event pertaining to the electromagnetic coupling 114-1 such that the at least one function of the first circuitry 112 remains disabled in response to clearance of the tamper event. The anti-tamper circuitry may be coupled to a sensor 610 configured to detect a first magnetic field 614 generated by the source 620.

In some implementations, the anti-tamper circuitry 110 may be configured to detect the tamper event in response to a strength of the first magnetic field 614 detected by the sensor failing to satisfy a threshold. The threshold may be configured in accordance with tolerance characteristics of one or more of the sensor 610 and the source 620 of the first magnetic field 614.

In some embodiments, the anti-tamper circuitry 110 may be configured to detect the tamper event in response to detection of a second magnetic field 614S different to the first magnetic field 614. The anti-tamper circuitry 110 may comprise a secondary sensor 610S configured to detect the second magnetic field 614S. The anti-tamper circuitry 110 may be configured to distinguish the second magnetic field 614S from the first magnetic field 614 based, at least in part, on an orientation of the second magnetic field 614S. In some embodiments, the device 102 may further comprise electromagnetic shielding 618 configured to shield the sensor 610 from a second or spoof magnetic field 614S different to the first magnetic field 614. The sensor 610 may be physically coupled to the first circuitry 112.

In some implementations, the anti-tamper circuitry 110, first circuitry 112, and sensor 610 may be disposed on a same printed circuit board. The source 620 may be physically coupled to circuitry 120 of the external component 104. The first circuitry 112 may comprise a tube auxiliary unit 1232 and the source 620 may be physically coupled to an x-ray tube 1236 of the external component 104.

Some embodiments include a method, comprising: monitoring an electromagnetic coupling 114-1 comprising a first magnetic field 614 generated by a source 620 disposed within an external component 104 by use of a sensor 610 physically coupled to circuitry 112 configured to control the external component 104; detecting a tamper event based, at least in part, on the monitoring; and disabling at least one function of the circuitry 112 in response to detecting the tamper event. The tamper event may be detected based on a magnetic field strength detected by the sensor 610. The tamper event may be detected in response to detection of a second magnetic field 614S different to the first magnetic field 614. The circuitry 112 and the sensor 610 may be disposed on a same structure (e.g., same circuit structure 604). In some implementations, the circuitry 112 and the sensor 610 may be disposed on a same printed circuit board. The tamper event may be detected in response to separation of the first circuitry 112 from the external component 104 by a distance threshold.

In some implementations, the method further comprises implementing one or more mitigation actions in response to detecting the tamper event, the mitigation actions comprising one or more of disconnecting the circuitry 112 from a system power source 820, connecting the circuitry 112 to an energy storage device 830, causing a tamper notification 601 to be transmitted over an electronic communication network, and causing data to be erased from a memory 812 of the circuitry 112.

Some embodiments include a system 602, comprising: an external component 104 comprising a source 620 configured to generate a magnetic field 614; a device 102 comprising first circuitry 112 configured to control the external component 104; a sensor 610 physically coupled to the first circuitry 112; and anti-tamper circuitry 110 electrically connected to the first circuitry 112 and configured to disable a function of the first circuitry 112 in response to a strength of the magnetic field 614 detected by the sensor 610 failing to satisfy a threshold.

The summary provided above is illustrative and is not intended to be in any way limiting. In addition to the examples described above, further aspects, features, and advantages of the invention will be made apparent by reference to the drawings, the following detailed description, and the appended claims.

Circuitry can include hardware, firmware, program code, executable code, computer instructions, and/or software. A non-transitory computer readable storage medium can be a computer readable storage medium that does not include a signal.

The operations described above may be implemented in various circuitry. For example, the operations may be implemented as a hardware circuit comprising custom very-large-scale integration (VLSI) circuits or gate arrays, including but not limited to logic chips, transistors, or other components. The operations may also be implemented in programmable hardware devices, including but not limited to field programmable gate arrays (FPGA), programmable array logic, programmable logic devices or similar devices.

Reference throughout this specification to an “example” or an “embodiment” means that a particular feature, structure, or characteristic described in connection with the example is included in at least one embodiment of the invention. Thus, appearances of the words an “example” or an “embodiment” in various places throughout this specification are not necessarily all referring to the same embodiment.

Furthermore, the described features, structures, or characteristics may be combined in a suitable manner in one or more embodiments. In the following description, numerous specific details are provided (e.g., examples of layouts and designs) to provide a thorough understanding of embodiments of the invention. One skilled in the relevant art will recognize, however, that the invention can be practiced without one or more of the specific details, or with other methods, components, layouts, etc. In other instances, well-known structures, components, or operations are not shown or described in detail to avoid obscuring aspects of the invention.

Elements specifically recited in means-plus-function format, if any, are intended to be construed to cover the corresponding structure, material, or acts described herein and equivalents thereof in accordance with 35 U.S.C. § 112 ¶ 6.

While the forgoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited. Various features and advantages of the invention are set forth in the following claims.

1. A device configured to be mounted to an external component, comprising:
first circuitry configured to control the external component;
anti-tamper circuitry electrically connected to the first circuitry; and
an electromagnetic coupling established between the anti-tamper circuitry and a source disposed within the external component;
wherein the anti-tamper circuitry is configured to disable at least one function of the first circuitry in response to detecting a tamper event pertaining to the electromagnetic coupling such that the at least one function of the first circuitry remains disabled in response to clearance of the tamper event.

2. The device of claim 1, wherein the anti-tamper circuitry is coupled to a sensor configured to detect a first magnetic field generated by the source.

3. The device of claim 2, wherein the anti-tamper circuitry is configured to detect the tamper event in response to a strength of the first magnetic field detected by the sensor failing to satisfy a threshold.

4. The device of claim 3, wherein the threshold is configured in accordance with tolerance characteristics of one or more of the sensor and the source of the first magnetic field.

5. The device of claim 2, wherein the anti-tamper circuitry is configured to detect the tamper event in response to detection of a second magnetic field different to the first magnetic field.

6. The device of claim 5, wherein the anti-tamper circuitry comprises a secondary sensor configured to detect the second magnetic field.

7. The device of claim 5, wherein the anti-tamper circuitry is configured to distinguish the second magnetic field from the first magnetic field based, at least in part, on an orientation of the second magnetic field.

8. The device of claim 2, further comprising electromagnetic shielding configured to shield the sensor from a second magnetic field different to the first magnetic field.

9. The device of claim 2, wherein the sensor is physically coupled to the first circuitry.

10. The device of claim 2, wherein the anti-tamper circuitry, first circuitry, and sensor are disposed on a same printed circuit board.

11. The device of claim 1, wherein the source is physically coupled to circuitry of the external component.

12. The device of claim 1, wherein the first circuitry comprises a tube auxiliary unit and wherein the source is physically coupled to an x-ray tube of the external component.

13. A method, comprising:
monitoring an electromagnetic coupling comprising a first magnetic field generated by a source disposed within an external component by use of a sensor physically coupled to circuitry configured to control the external component;
detecting a tamper event based, at least in part, on the monitoring; and
disabling at least one function of the circuitry in response to detecting the tamper event.

14. The method of claim 13, wherein the tamper event is detected based on a magnetic field strength detected by the sensor.

15. The method of claim 13, wherein the tamper event is detected in response to detection of a second magnetic field different to the first magnetic field.

16. The method of claim 13, wherein the circuitry and the sensor are disposed on a same structure.

17. The method of claim 16, wherein the circuitry and the sensor are disposed on a same printed circuit board.

18. The method of claim 16, wherein the tamper event is detected in response to separation of the circuitry from the external component by a distance threshold.

19. The method of claim 13, further comprising implementing one or more mitigation actions in response to detecting the tamper event, the mitigation actions comprising one or more of disconnecting the circuitry from a system power source, connecting the circuitry to an energy storage device, causing a tamper notification to be transmitted over an electronic communication network, and causing data to be erased from a memory of the circuitry.

20. An anti-tamper system, comprising:
an external component comprising a source configured to generate a magnetic field;
a device comprising first circuitry configured to control the external component;
a sensor physically coupled to the first circuitry; and
anti-tamper circuitry electrically connected to the first circuitry and configured to disable a function of the first circuitry in response to a strength of the magnetic field detected by the sensor failing to satisfy a threshold.
